(19) United States
(12) Patent Application Publication
(10) Pub. No.: US 2016/0055044 A1
(43) Pub. Date: Feb. 25, 2016

(54) FAULT ANALYSIS METHOD, FAULT ANALYSIS SYSTEM, AND STORAGE MEDIUM

(71) Applicant: HITACHI, LTD., Chiyoda-ku, Tokyo (JP)

(72) Inventors: RYO KAWAI, Tokyo (JP); Yuji MIZOTE, Tokyo (JP)

(73) Assignee: HITACHI, LTD., Tokyo (JP)

(21) Appl. No.: 14/771,251

(22) PCT Filed: May 16, 2013
(86) PCT No.: PCT/JP2013/063704

§ 371 Date: Aug. 28, 2015

(51) Int. Cl. G06F 11/07; G06N 99/00; G06N 7/00

(52) U.S. Cl. CPC G06F 11/079; G06F 11/0709; G06F 11/0751; G06N 7/005; G06N 99/005

(57) ABSTRACT

[Object]

Proposed are a fault analysis method, a fault analysis system and a storage medium which improve the availability of a computer system.

[Solution]

Monitoring data is continuously acquired from a monitoring target system comprising one or more computers, and behavioral models which are obtained by modeling the behavior of the monitoring target system are created at regular or irregular intervals based on the acquired monitoring data, the respective differences between two consecutively created behavioral models are calculated and, based on the calculation result, a period in which the behavior of the monitoring target system has changed is estimated, and a user is notified of the period in which the behavior of the monitoring target system is estimated to have changed.

### TECHNICAL FIELD

The present invention relates to a fault analysis method, a fault analysis system and a storage medium and is suitably applied to a large-scale computer system, for example.

### BACKGROUND ART

Conventionally, when a fault occurs in a computer system, the system administrator has specified the cause of the fault by analyzing the previous state of the computer system, but the decision at the time of whether or not to analyze the state of the computer system retroactively up to that point depends upon the system administrator's experience. More specifically, the system administrator analyzes the log files, memory dump and history of system changes in order to check the information of a system fault and search for the cause of the system fault. In searching for the cause of the system fault, the system administrator works backwards through the log files and history of changes to the system to confirm the generation of a system anomaly. Here, based on prior experience, the system administrator estimates the time it will take to check the log files to confirm the fault generated and exercises trial and error until the cause of the fault is found.

In recent years, the information systems environment has witnessed the proliferation of cloud computing, and advances in large-scale computer systems due to the increased demands on analytical applications using large volumes of data. Advances in large-scale computer systems have led to an increase in the number of servers required for analysis when a system fault arises and a greater complexity in the devices and applications in the computer system as well as in the data relativity. In this case, the work load on the system administrator increases and it takes a lot of time to specify and analyze the cause of a computer system fault. Further, there is a risk of an identical fault recurring or a similar fault being generated in the computer system and then task stoppage before the cause of a computer system fault is clear.

One reason that it takes time to specify and analyze the cause of a computer system fault is that it is difficult to ascertain the point when there is a change in the behavior of the computer system (such changes include not only simple points in time but also certain periods and are referred to hereinbelow as a ‘system change points’). Computer system faults occur for the most part when a computer system that is operating stably undergoes some kind of change such as a configuration change or applying a patch, or when a user access pattern changes, so if this kind of system change point can be ascertained, a shortening in the time required to specify and analyze the cause of the fault can be expected. System change points can be broadly divided into cases where there is a physical change such as the addition or removal of a task device to/from the computer system and cases where there is no physical change but a change in the way the computer system behaves such as a change in the access pattern.

Technology for extracting and managing system change points includes the technologies disclosed in Patent Literatures 1 to 4, for example. For example, Patent Literatures 1 and 3 disclose technology for extracting and managing changes in the behavior of a computer system from changes in the behavior of monitored items of the computer system, while Patent Literatures 2 and 4 disclose technologies for extracting and managing physical changes in a computer system.

### CITATION LIST

### Patent Literature

### [PTL 1]

PCT International Patent Publication No. 2010/032701

### [PTL 2]

Specification of U.S. Pat. No. 6,205,122

### [PTL 3]

Specification of U.S. Pat. No. 6,182,022

### [PTL 4]

Specification of U.S. Unexamined Patent Application No. 2010/0095273

### SUMMARY OF INVENTION

### Technical Problem

However, according to the technologies disclosed in PTL 2 and PTL 4, there is a problem in that system change points cannot be extracted and managed when there is a change in the access pattern of the computer system, for example, without an accompanying physical change.

Furthermore, according to the technologies disclosed in PTL 1 and PTL 3, there is a problem in that it is impossible to describe a relationship such as one where the behavior of a certain monitored item in a computer system is affected by the behavior of a plurality of monitored items.

For example, in a computer system comprising a web server, an application server and a database server, the time taken to receive a response after a user submits a request (the response time) is greatly affected by the behavior of a plurality of monitored items such as the CPU (Central Processing Unit) of the web server and the application server and the memory usage of the database server.

Therefore, it is hard to capture the behavior of a whole computer system, and in the technologies disclosed in PTL 1 and PTL 3, changes in the behavior of one or two monitored items cannot be captured and the relationship required for the computer system analysis cannot be perceived. More specifically, according to the technologies disclosed in PTL 1 and PTL 3, there is a problem in that it is impossible to deal with cases where three or more monitored items relate to one another (an event where an N to 1 or 1 to N relationship is established).

Hence, if the foregoing problems could be resolved, it would be possible to shorten the time required to specify and analyze the cause of a computer system fault. Further, as a result, consideration has been given to being able to reduce the probability of a system fault recurring after provisional measures have been taken and to being able to improve the availability of the computer system.

The present invention was conceived in view of the above points and proposes a fault analysis method, a fault analysis system, and a storage medium which enable an improved availability of the computer system.

### Solution to Problem

In order to solve such problem, the present invention is a fault analysis method for performing a fault analysis on a monitoring target system comprising one or more computers, comprising a first step of continuously acquiring monitoring data from the monitoring target system and creating behavioral models which are obtained by modeling the behavior of the monitoring target system at regular or irregular intervals based on the acquired monitoring data, a second step of calculating the respective differences between two consecutively created behavioral models and estimating, based on the calculation result, a period in which the behavior of the monitoring target system has changed, and a third step of notifying a user of the period in which the behavior of the monitoring target system is estimated to have changed.

Furthermore, the present invention is fault analysis system for performing a fault analysis on a monitoring target system comprising one or more computers, comprising: a behavioral model creation [unit] for continuously acquiring, from the monitoring target system, monitoring data which is statistical data for monitored items of the monitoring target system and creating behavioral models which are obtained by modeling the behavior of the monitoring target system at regular or irregular intervals based on the acquired monitoring data; an estimation unit for calculating the respective differences between two consecutively created behavioral models and estimating, based on the calculation result, a period in which the behavior of the monitoring target system has changed; and a notification unit for notifying a user of the period in which the behavior of the monitoring target system is estimated to have changed.

Further, the present invention was devised such that the fault analysis system for performing a fault analysis on a monitoring target system comprising one or more computers stores programs which execute processing, comprising: a first step of continuously acquiring, from the monitoring target system, monitoring data which is statistical data for monitored items of the monitoring target system, and creating behavioral models which are obtained by modeling the behavior of the monitoring target system at regular or irregular intervals based on the acquired monitoring data; a second step of calculating the respective differences between two consecutively created behavioral models and estimating, based on the calculation result, a period in which the behavior of the monitoring target system has changed; and a third step of notifying a user of the period in which the behavior of the monitoring target system is estimated to have changed.

According to the fault analysis method, fault analysis system and storage medium of the present invention, when a system fault occurs in a monitoring target system, the user is able to easily identify a period in which the behavior of the monitoring target system is estimated to have changed, whereby the time taken to specify and analyze the cause of the computer system fault can be shortened.

### Advantageous Effects of Invention

The present invention makes it possible to reduce the probability of a system fault recurring after provisional measures have been taken and enables an improved availability of a computer system.

### BRIEF DESCRIPTION OF DRAWINGS

FIG. 1 is a perspective view illustrating a Bayesian network.

FIG. 2 is a perspective view illustrating the hidden Markov model.

FIG. 3 is a perspective view illustrating a support vector machine.

FIG. 4 is a block diagram showing a skeleton framework of a computer system according to a first embodiment.

FIG. 5 is a block diagram showing a hardware configuration of the computer system of FIG. 1.

FIG. 6 is a perspective view illustrating a system fault analysis function according to the first embodiment.

FIG. 7 is a perspective view illustrating a configuration of a monitoring data management table according to the first embodiment.

FIG. 8 is a perspective view illustrating a configuration of a behavioral model management table according to the first embodiment.

FIG. 9 is a perspective view illustrating a configuration of a system change point configuration table according to the first embodiment.

FIG. 10A is a schematic diagram showing a skeleton framework of a fault analysis screen according to the first embodiment and FIG. 10B is a schematic diagram of a skeleton framework of a log information screen.

FIG. 11 is a flowchart showing a processing routine for behavioral model creation processing according to the first embodiment.

FIG. 12 is a flowchart showing a processing routine for change point estimation processing according to the first embodiment.

FIG. 13 is a flowchart showing a processing routine for change point display processing.

FIG. 14 is a block diagram showing a skeleton framework of a computer system according to a second embodiment.

FIG. 15 is a perspective view showing a configuration of a behavioral model management table according to the second embodiment.

FIG. 16 is a perspective view illustrating a configuration of a system change point configuration table according to the second embodiment.

FIG. 17 is a schematic diagram showing a skeleton framework of a first fault analysis screen according to the second embodiment.

FIG. 18 is a schematic diagram showing a skeleton framework of a second fault analysis screen according to the second embodiment.

FIG. 19 is a flowchart showing a processing routine for behavioral model creation processing according to the second embodiment.

FIG. 20A is a flowchart showing a processing routine for change point estimation processing according to the second embodiment.

FIG. 20B is a flowchart showing a processing routine for change point estimation processing according to the second embodiment.

FIG. 21 is a block diagram showing a skeleton framework of a computer system according to a third embodiment.

FIG. 22 is a perspective view of a configuration of a system change point configuration table according to the third embodiment.

FIG. 23 is a perspective view of a configuration of an event management table.

FIG. 24 is a schematic diagram showing a skeleton framework of a fault analysis screen according to the third embodiment.

FIG. 25 is a flowchart showing a processing routine for change point estimation processing according to the third embodiment.

FIG. 26 is a block diagram showing a skeleton framework of a computer system according to a fourth embodiment.

FIG. 27 is a perspective view of a configuration of a system change point configuration table according to the fourth embodiment.

FIG. 28 is a schematic diagram showing a skeleton framework of a fault analysis screen according to the fourth embodiment.

FIG. 29 is a flowchart showing a processing routine for change point estimation processing according to the fourth embodiment.

### DESCRIPTION OF EMBODIMENTS

An embodiment of the present invention will be described in detail hereinbelow with reference to the drawings.

### (1) First Embodiment

### (1-1) Machine Learning Algorithm

Conventionally, the Bayesian network, hidden Markov model, and support vector machine and the like are widely known as algorithms for inputting and machine-learning large volumes of monitoring data.

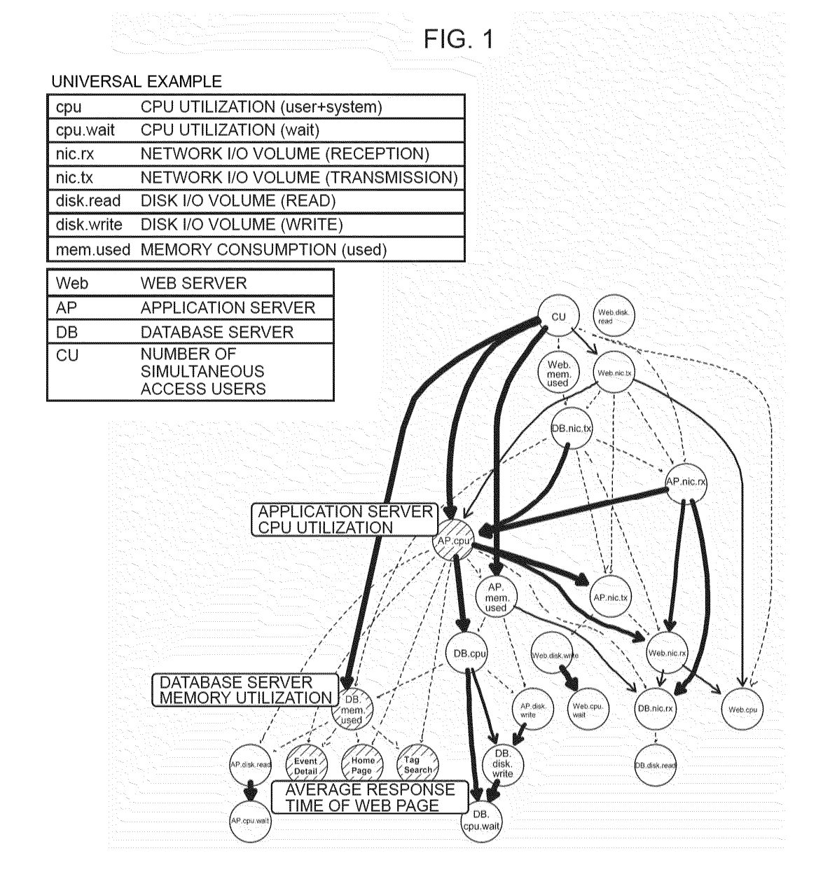

The Bayesian network is a method for modeling the stochastic causal relationship (the relationship between cause and effect) between a plurality of events based on Bayes' theorem and, as shown in FIG. 1, expresses the causal relation by means of a digraph and gives the strength of the causal relation by way of a conditional probability. The probability of a certain event occurring due to another event arising is calculated on a case by case basis using information collected up to that point, and by calculating each of these cases according to the paths via which these events occurred, it is possible to quantitatively determine the probabilities of these causal relations occurring with a plurality of paths.

Note that Bayes' theorem is also referred to as ‘posterior probability’ and is a method for calculating causal probability. More specifically, for an incident in a cause and effect relationship, the probability of each conceivable cause occurring is calculated when a certain effect arises by using the probability of the cause and effect each occurring individually (individual probability) and the conditional probability of a certain effect being produced after each cause has occurred.

FIG. 1 shows a configuration example of a web system behavioral model which was created by using a Bayesian network in a web system comprising three servers, namely, a web server, an application server, and a database server. As described hereinabove, a Bayesian network can be expressed via a digraph and monitored items are configured for nodes (as indicated by the empty circle symbols in FIG. 1). Further, transition weightings are assigned to edges between nodes (dashed or solid lines linking nodes in FIG. 1) and in FIG. 1, the transition weightings are expressed by the thickness of the edges. Hereinafter, the distances between behavioral models are calculated using the transition weightings.

FIG. 1 shows that the behavior of the average response time of web pages is affected by the behavior of the CPU utilization of the application server and the behavior of the memory utilization of the database server. The phrase “a relationship such as one where the behavior of a certain monitored item . . . is affected by the behavior of a plurality of monitored items” which was mentioned in the foregoing problems can also be understood from FIG. 1.

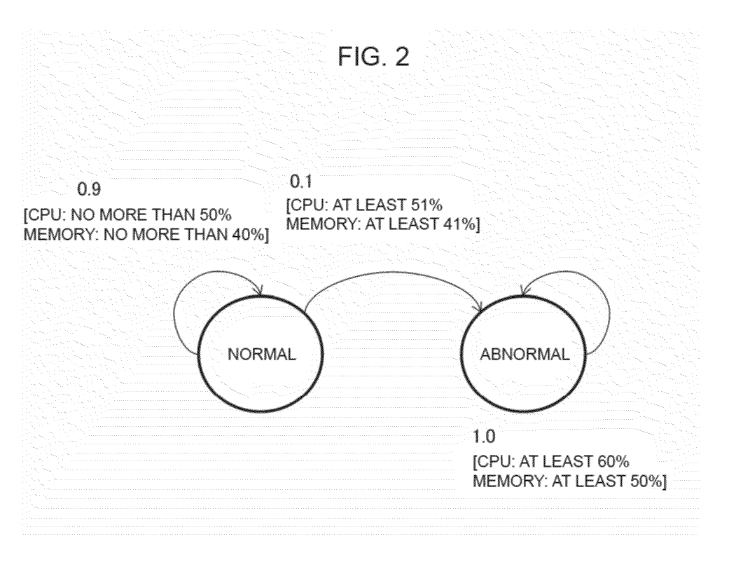

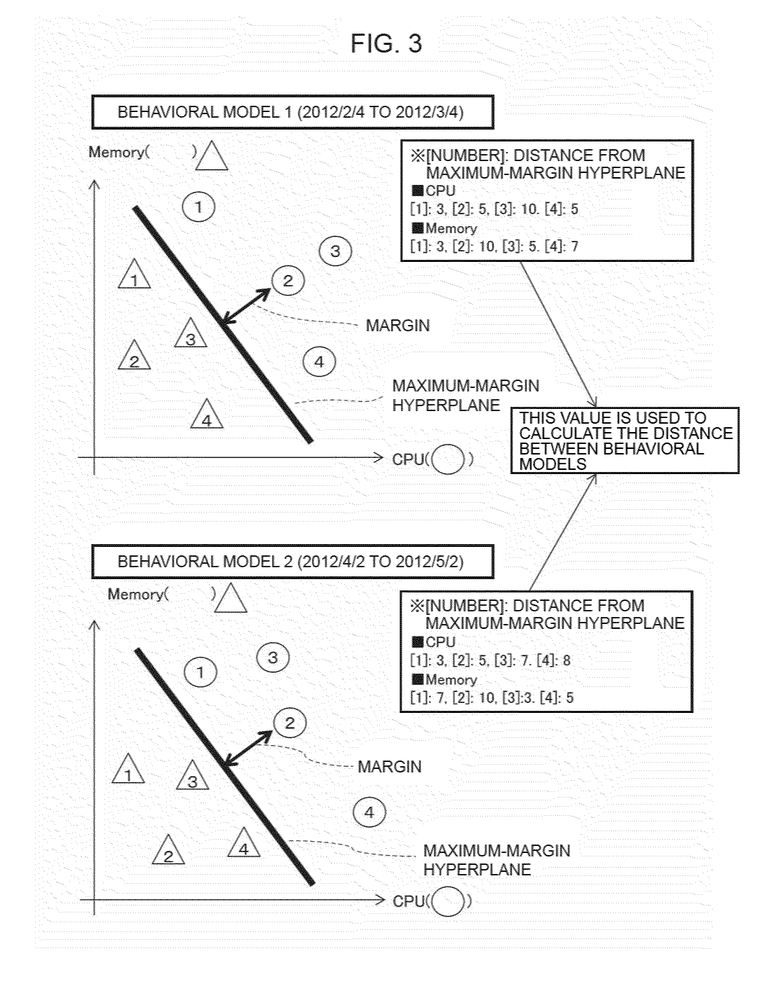

The hidden Markov model is a method in which a system serving as a target is assumed to be governed by a Markov process with unknown parameters and the unknown parameters are estimated from observable information, where relationships between states are expressed using a digraph and their strengths are given by the probabilities of transition between states as shown in FIG. 2. In FIG. 2, there are three states exhibited by the system and the transition probability of each state is shown. Further, the probability that events (a, b in FIG. 2) observed in the transitions to each state will occur is shown in brackets [ ]. This is because it is possible to perceive grammar and so forth in speech mechanisms and natural language as Markov chains according to unknown observed parameters.

Note that a Markov process is a probability process with the Markov property. The Markov property refers to performance where a conditional probability of a future state only depends on the current state and not on a past state. Hence, the current state is given by the conditional probability of the past state. Further, a Markov chain denotes the discrete (finite or countably infinite) states that can be assumed in a Markov process.

FIG. 2 shows an example of the foregoing behavioral model of a web system comprising three servers, namely, an application server and a database server and which was created using a hidden Markov model. The number of states in the monitoring target system can be considered as two at the very least, namely, ‘normal’ and ‘abnormal,’ for example. Note that the number of states depends on the units of the performed analysis and that FIG. 2 is one such example. Further, each of the monitored items can be captured as events which are observed in the course of the transition to each state and, when transitioning from a certain state to a given state, the value of each monitored item can be expressed by the extent to which the monitored item was observed. Here “the extent to which the monitored item was observed” means that a monitored item has been observed when a certain value is reached or exceeded, for example, and a relationship where the value of a monitored item is equal to or more than a certain value when transitioning from a certain state A to a state B can be expressed accordingly.

A support vector machine is a method for configuring a data classifier by using the simplest linear threshold element as a neuron model. By finding the maximum-margin hyperplane, at which the distance is maximum between each data point, from a learning data sample, the data provided can be separated. Here, the maximum-margin hyperplane is a plane for which it has been determined that the data provided can be optimally categorized according to some kind of standard. In a case where two-dimensional axes are considered, a plane is a line.

### (1-2) Configuration of a Computer System According to this Embodiment

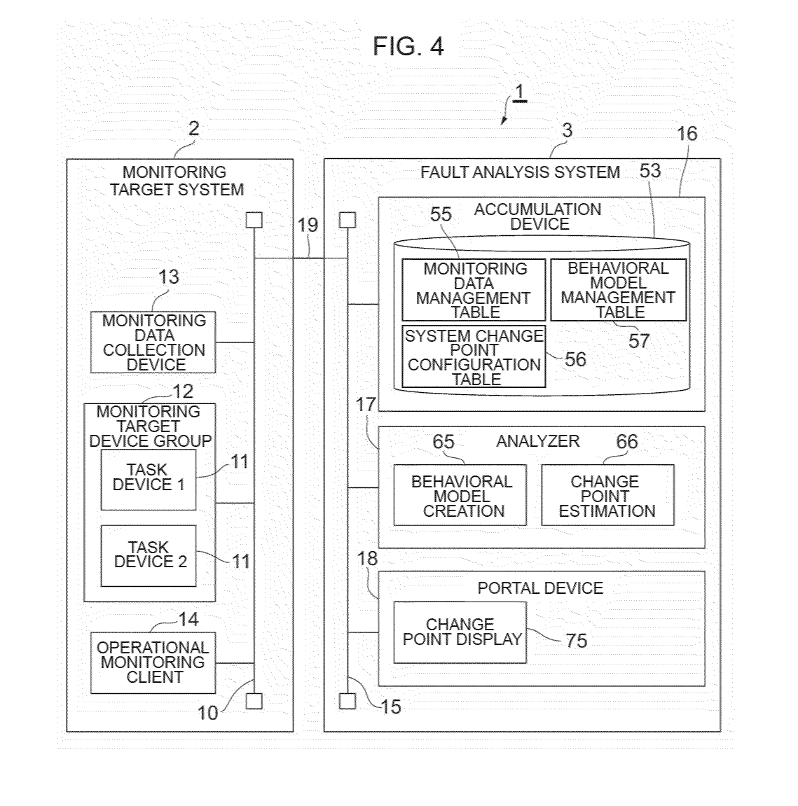

FIG. 4 shows a computer system 1 according to this embodiment. This computer system 1 is configured comprising a monitoring target system 2 and a fault analysis system 3.

The monitoring target system 2 comprises a monitoring target device group 12 comprising a plurality of task devices 11 which are monitoring targets, a monitoring data collection device 13, and an operational monitoring client 14 which are mutually connected via a first network 10. Further, the fault analysis system 3 comprises an accumulation device 16, an analyzer 17, and a portal device 18, which are mutually connected via a second network 15. Further, the first and second networks 10 and 15 respectively are connected via a third network 19.

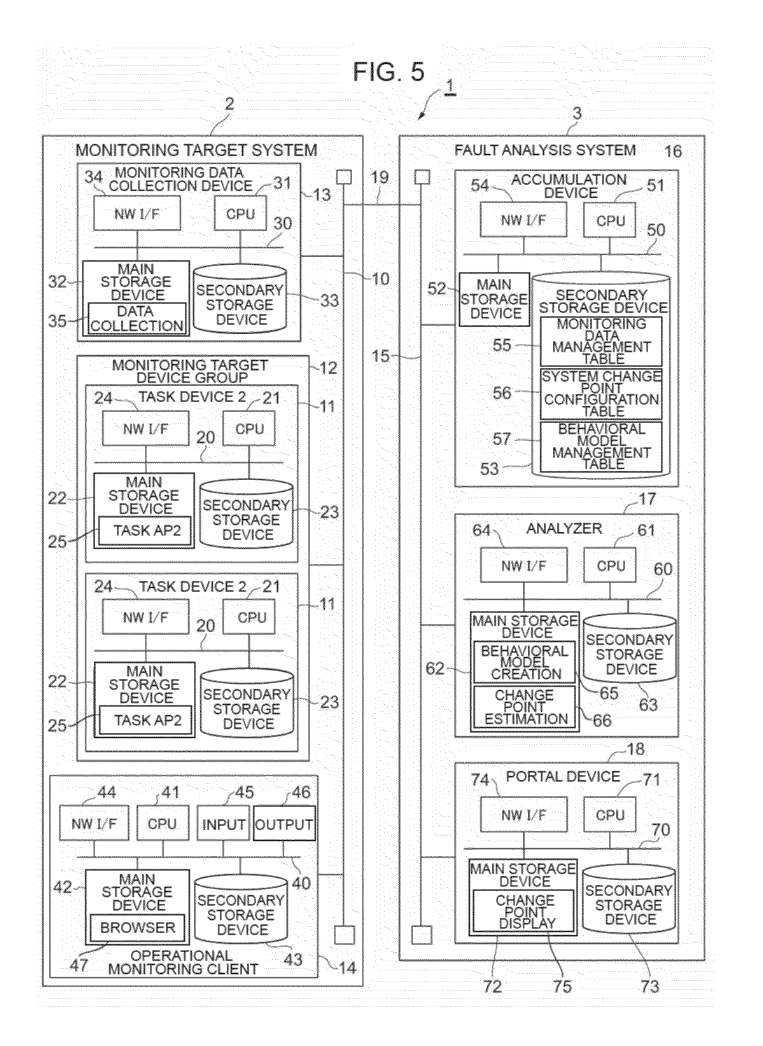

FIG. 5 shows a skeleton framework of the task devices 11, the monitoring data collection device 13, the operational monitoring client 14, the accumulation device 16, the analyzer 17 and the portal device 18.

The task device 11 is a computer, on which a task application 25 suited to the content of the user's task has been installed, which is configured comprising a web server, an application server, or a database server or the like, for example. The task device 11 is configured comprising a CPU 21, a main storage device 22, a secondary storage device 23 and a network interface 24 which are mutually connected via an internal bus 20.

The CPU 21 is a processor which governs the operational control of the whole task device 11. Further, the main storage device 22 is configured from a volatile semiconductor memory and is mainly used to temporarily store and hold programs and data and so forth. The secondary storage device 23 is configured from a large-capacity storage device such as a hard disk device and stores various programs and various data requiring long-term storage. When the task device 11 is started and various processing is executed, programs which are stored in the secondary storage device 23 are read to the main storage device 22 and various processing for the whole task device 11 is executed as a result of the programs read to the main storage device 22 being executed by the CPU 21. The task application 25 is also read from the secondary storage device 23 to the main storage device 22 and executed by the CPU 21.

The network interface 24 has a function for performing protocol control during communications with other devices connected to the first and second networks 10 and 15 respectively and is configured from an NIC (Network Interface Card), for example.

The monitoring data collection device 13 is a computer with a function for monitoring each of the task devices 11 which the monitoring target device group 12 comprises and comprises a CPU 31, a main storage device 32, a secondary storage device 33 and a network interface 34 which are mutually connected via an internal bus 30. The CPU 31, main storage device 32, secondary storage device 33 and network interface 34 possess the same functions as the corresponding parts of the task devices 11 and therefore a description of these parts is omitted here.

The main storage device 32 of the monitoring data collection device 13 stores and holds a data collection program 35 which is read from the secondary storage device 33. As a result of the CPU 31 executing the data collection program 35, the monitoring processing to monitor the task devices 11 is executed by the whole monitoring data collection device 13. More specifically, the monitoring data collection device 13 continuously collects (at regular or irregular intervals) statistical data (hereinafter called ‘monitoring data’) for one or more predetermined monitored items such as the response time, CPU utilization and memory utilization from each task device 11, and transfers the collected monitoring data to the accumulation device 16 of the fault analysis system 3.

The operational monitoring client 14 is a communication terminal device which the system administrator uses when accessing the portal device 18 of the fault analysis system 3, the operational monitoring client 14 comprising a CPU 41, a main storage device 42, a secondary storage device 43, a network interface 44, an input device 45 and an output device 46, which are mutually connected via an internal bus 40.

Among these devices, the CPU 41, main storage device 42, secondary storage device 43, and network interface 44 possess the same functions as the corresponding parts of the task devices 11 and hence a description of these parts is omitted here. The input device 45 is a device with which the system administrator inputs various instructions and is configured from a keyboard and a mouse, or the like. Further, the output device 46 is a display device for displaying various information and a GUI (Graphical User Interface) and is configured from a liquid crystal panel or the like.

The main storage device 42 of the operational monitoring client 14 stores and holds a browser 47 which is read from the secondary storage device 43. Further, as a result of the CPU 41 executing the browser 47, various screens are displayed on the output device 46 based on image data which is transmitted from the portal device 18, as will be described subsequently.

The accumulation device 16 is a storage device which is used to accumulate monitoring data and so forth which is acquired from each of the task devices 11 and transferred from the monitoring data collection device 13, and which is configured comprising a CPU 51, a main storage device 52, a secondary storage device 53, and a network interface 54 which are mutually connected via an internal bus 50. The CPU 51, main storage device 52, secondary storage device 53 and network interface 54 possess the same functions as the corresponding parts of the task devices 11 and hence a description of these parts is omitted here. The secondary storage device 53 of the accumulation device 16 stores a monitoring data management table 55, a system change point configuration table 57 and a behavioral model management table 56 which will be described subsequently.

The analyzer 17 is a computer which possesses a function for analyzing the behavior of the monitoring target system 2 based on the monitoring data and the like which is stored in the accumulation device 16 and is configured comprising a CPU 61, a main storage device 62, a secondary storage device 63 and a network interface 64 which are mutually connected via an internal bus 60. The CPU 61, main storage device 62, secondary storage device 63 and network interface 64 possess the same functions as the corresponding parts of the task devices 11 and hence a description of these parts is omitted here. The main storage device 62 of the analyzer 17 stores a behavioral model creation program 65 and a change point estimation program 66 which are read from the secondary storage device 63 and will be described subsequently.

The portal device 18 is a computer which possesses functions for reading system change point-related information, described subsequently, from the accumulation device 16 in response to requests from the operational monitoring client 14 and displaying the information thus read on the output device 46 of the operational monitoring client 14, and is configured comprising a CPU 71, a main storage device 71, a secondary storage device 73 and a network interface 74 which are mutually connected via an internal bus 70. The CPU 71, main storage device 72, secondary storage device 73 and network interface 74 possess the same functions as the corresponding parts of the task devices 11 and hence a description of these parts is omitted here. The secondary storage device 73 of the portal device 18 stores a change point display program 75 which will be described subsequently.

### (1-3) System Fault Analysis Function According to this Embodiment

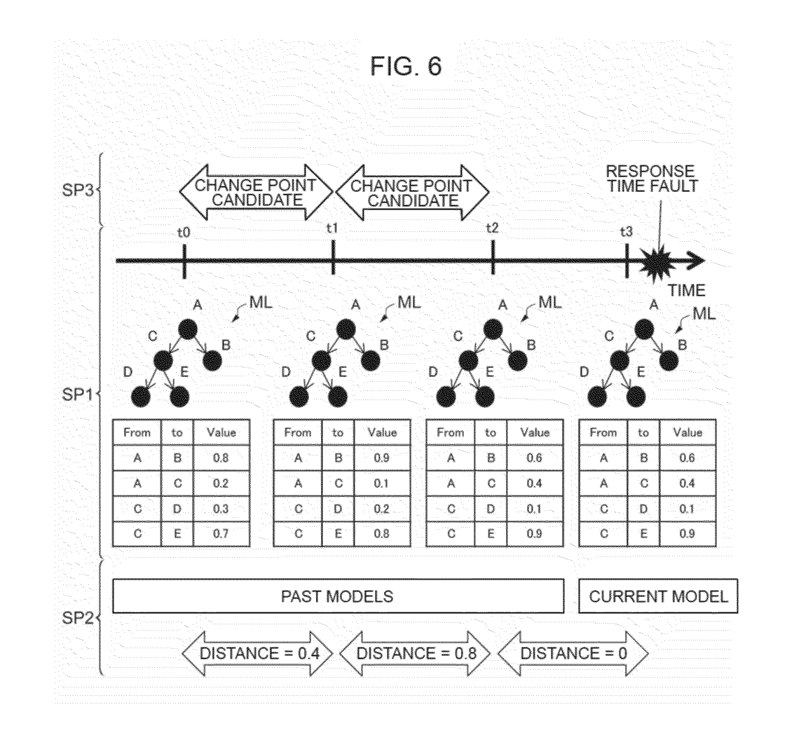

A system fault analysis function which is installed on this computer system 1 will be described next. As shown in FIG. 6, this system fault analysis function is a function which creates behavioral models ML, which are obtained by modeling the behavior of the monitoring target system 2, at regular or irregular intervals (SP1), which calculates, when a system fault occurs in the monitoring target system 2, the respective differences between each of the temporally consecutive behavioral models ML created up to that point (hereinafter these differences will be called the ‘distances between behavioral models ML’) (SP2), estimates, based on the calculation result, the period in which the system change points of the monitoring target system 2 are thought to exist (SP3), and notifies the user (hereinafter the ‘system administrator’) of the estimation result.

In reality, in the case of the computer system 1, the analyzer 17 acquires monitoring data for each of the monitored items stored in the accumulation device 16 after being collected from each of the task devices 11 by the monitoring data collection device 13 at regular intervals in response to instructions from an installed scheduler (not shown) or at irregular intervals in response to instructions from the system administrator. The analyzer 17 then executes machine learning with the inputs of the acquired monitoring data for each of the monitored items and creates the behavioral models ML for the monitoring target system 2.

Furthermore, when a system fault occurs in the monitoring target system 2, the analyzer 17 calculates, for each behavioral model ML, the distance between two consecutive behavioral models ML created at regular or irregular intervals as described above, in response to an instruction from the system administrator which is provided via the operational monitoring client 14, and estimates that the system change point lies in a period between the dates and times when two behavioral models ML, for which the calculated distance is equal to or more than a predetermined value (hereinafter called the distance threshold value), were created.

In addition, the portal device 18 generates screen data for a screen (hereinafter called a ‘fault analysis screen’) displaying information relating to the period in which the system change point estimated by the analyzer 17 is thought to exist, and by transmitting the generated screen data to the operational monitoring client 14, the portal device 18 displays the fault analysis screen on the output device 46 (FIG. 5) of the operational monitoring client 14 based on this screen data.

As means for implementing the system fault analysis function according to this embodiment as described above, the secondary storage device 53 of the accumulation device 16 stores, as mentioned earlier, the monitoring data management table 55, the behavioral model management table 56 and the system change point configuration table 57: the main storage device 62 of the analyzer 17 stores the behavioral model creation program 65 and the change point estimation program 66; and the main storage device 72 of the portal device 18 stores the change point display program 75.

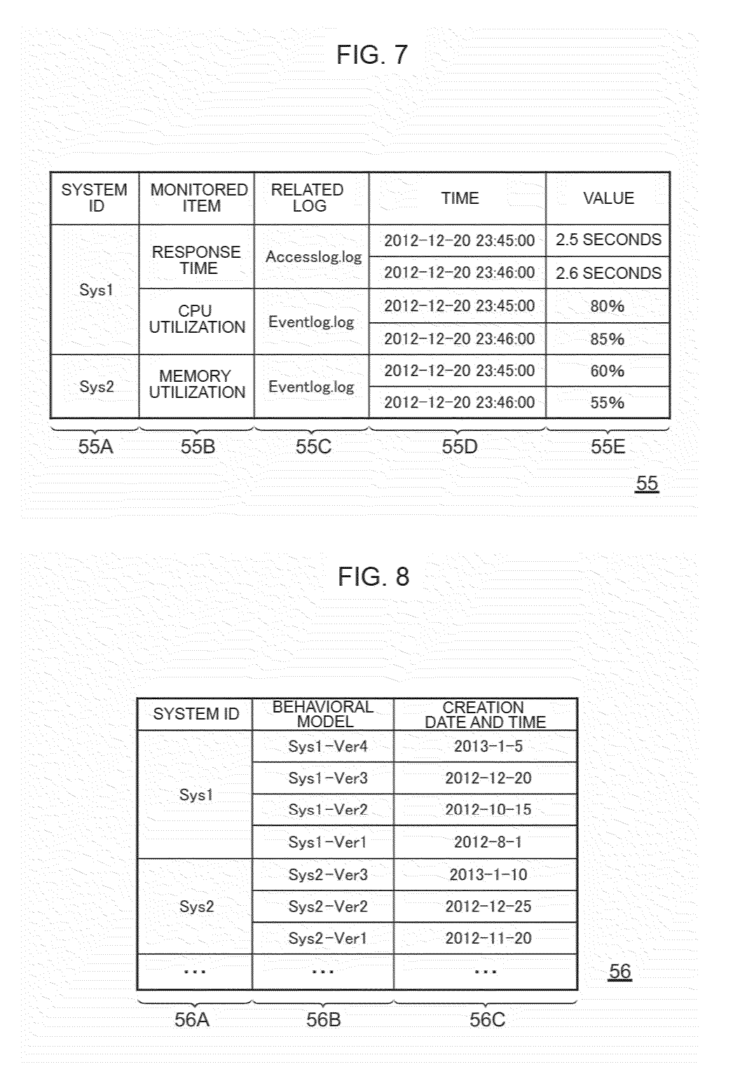

The monitoring data management table 55 is a table used to manage monitoring data which is transferred from the monitoring data collection device 13 and, as shown in FIG. 7, is configured from a system ID field 55A, a monitored item field 55B, a related log field 55C, a time field 55D and a value field 55E.

Among these, the system ID field 55A stores the IDs of the monitoring target systems 2 serving as the monitoring targets (hereinafter called the ‘system IDs’) and the monitored item field 55B stores the item names of predetermined monitored items for the monitoring target systems 2 for which the system IDs are provided. The related log field 55C stores the file names of the log files for which log information is recorded when monitoring data for the corresponding monitored item is transmitted. Note that these log files are stored in a separate storage area in the secondary storage device 53 of the accumulation device 16. Further, the time field 55D stores the times when the monitoring data for the corresponding monitored items is acquired and the value field 55E stores the values of the corresponding monitored items acquired at the corresponding times.

Accordingly, in the example in FIG. 7, it can be seen that for the monitoring target system 2 known as ‘Sys1,’ for example, two monitored items of the task devices 11 are configured, namely, the ‘response time’ and ‘CPU utilization,’ and that log information, when the monitoring data of the corresponding monitored items is transmitted, is recorded in the log files ‘AccessLog.log’ and ‘EventLog.log’ respectively in the secondary storage device 53 of the accumulation device 16. Further, in this case, it can be seen that the monitoring data is acquired at ‘2012:12:20 23:45:00’ and ‘2012:12:20 23:46:00’ for the monitored item ‘response time’ and that the values of the monitoring data are ‘2.5 seconds’ and ‘2.6 seconds’ respectively.

The behavioral model management table 56 is a table used to manage the behavioral models ML (FIG. 6) of the monitoring target system 2 which are created by the analyzer 17 and is configured from a system ID field 56A, a behavioral model field 56B and a creation date-time field 56C, as shown in FIG. 8.

Further, the system ID field 56A stores the system IDs of the monitoring target systems 2 which are the monitoring targets and the behavioral model field 56B stores the data of the behavioral models ML created for the corresponding monitoring target systems 2. Further, the creation date-time field 56C stores the creation dates and times of the corresponding behavioral models ML.

Accordingly, in the example of FIG. 8, it can be seen that, for the monitoring target system 2 known as “Sys1,” for example, the behavioral model ML known as ‘Sys1-Ver1’ was created on ‘0212-8-1,’ the behavioral model ML known as ‘Sys1-Ver2’ was created on ‘0212-10-15,’ the behavioral model ML known as ‘Sys1-Ver3’ was created on ‘0212-12-20,’ and the behavioral model ML known as ‘Sys1-Ver4’ was created on ‘0213-1-5.’

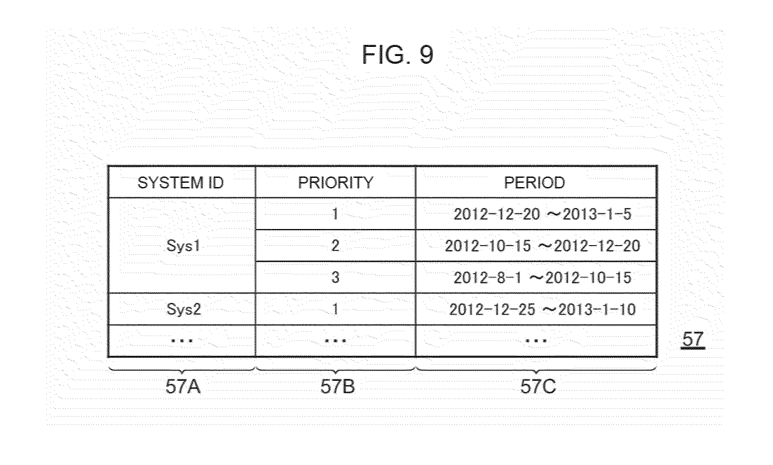

The system change point configuration table 57 is a table used to manage the periods containing the system change points estimated by the analyzer 17 for each of the monitoring target systems 2 and, as shown in FIG. 9, is configured from a system ID field 57A, a priority field 57B and a period field 57C.

Further, the system ID field 57A stores the system IDs of the monitoring target systems 2 and the period field 57C stores the periods estimated to contain the system change points of the corresponding monitoring target systems 2. In addition, the priority field 57B stores the priorities of the periods containing the corresponding system change points. In the case of this embodiment, the priorities of the periods are assigned such that the highest priority is given to the newest period.

Accordingly, in the example of FIG. 9, it can be seen that, for the monitoring target system 2 known as “Sys1,” for example, system change points are estimated to exist in the periods ‘2012-12-20 to 2013-1-5,’ ‘2012-10-15 to 2012-12-20’ and ‘2012-8-1 to 2012-10-15’ respectively, and priorities are configured for these periods in this order.

Meanwhile, the behavioral model creation program 65 (FIG. 5) is a program which receives inputs of monitoring data stored in the monitoring data management table 55 of the accumulation device 16 and which possesses a function for creating behavioral models ML (FIG. 6) for the monitoring target system 2 serving as the monitoring target at the time by using a machine learning algorithm such as a Bayesian network, hidden Markov model or support vector machine. The data of the behavioral models ML created by the behavioral model creation program 65 is stored and held in the behavioral model management table 56 of the accumulation device 16.

Furthermore, the change point estimation program 66 (FIG. 5) is a program with a function for estimating the periods in which the system change points of the monitoring target systems 2 are thought to exist based on the behavioral models ML created by the behavioral model creation program 65. The periods in which the system change points estimated by the change point estimation program 66 are thought to occur are stored and held in the system change point configuration table 57 of the accumulation device 16.

The change point display program 75 is a program with a function for creating the aforementioned fault analysis screen. The change point display program 75 reads information relating to the system change points of a designated monitoring target system 2 from the system change point configuration table 57 and the like in accordance with a request from the system administrator via the operational monitoring client 14. Further, the change point display program 75 creates screen data for the fault analysis screen which displays the information thus read and, by transmitting the created screen data to the operational monitoring client 14, displays the fault analysis screen on the output device 46 of the operational monitoring client 14.

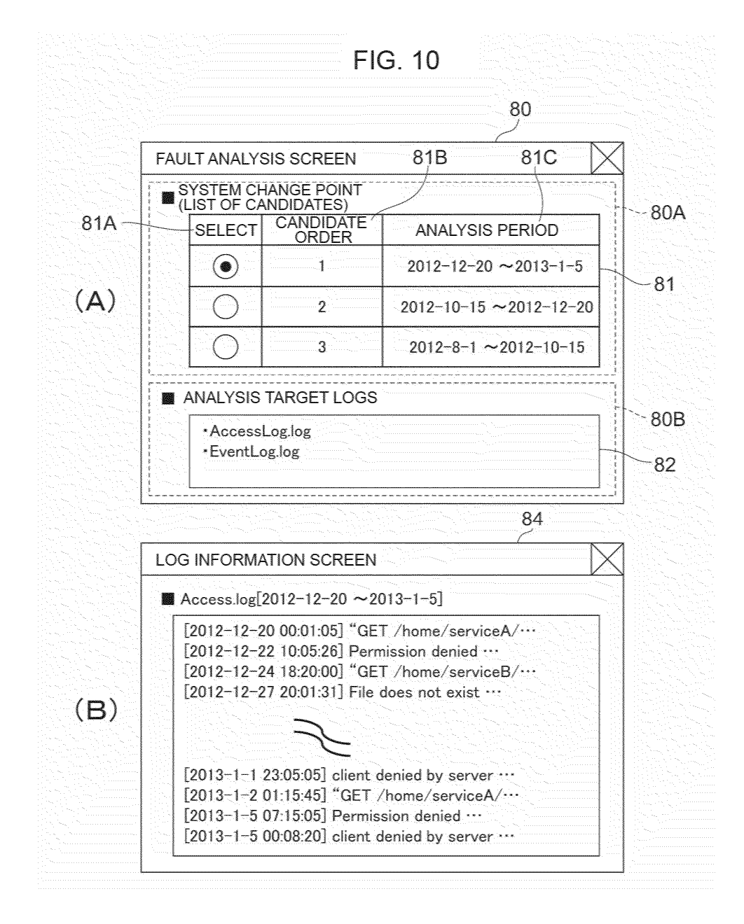

Note that the configuration of this fault analysis screen is shown in FIG. 10A. As is also clear from FIG. 10A, the fault analysis screen 80 is configured from a system change point information display field 80A and an analysis target log display field 80B. Further, the system change point information display field 80A displays a list 81 which displays periods in which system change points have been estimated to exist by the change point estimation program 66 (FIG. 5) (hereinafter called a ‘change point candidate list’), and the analysis target log display field 80B displays an analysis target log display field 82.

The change point candidate list 81 is configured from a selection field 81A, a candidate order field 81B and an analysis period field 81C. Further, the analysis period field 81C displays each of the periods in which system change points have been estimated to exist by the change point estimation program 66, and the candidate order field 81B displays the priorities assigned to the corresponding periods (system change points) in the system change point configuration table 57 (FIG. 5).

Further, a radio button 83 is displayed in each of the selection fields 81A. Only one of the radio buttons 83 can be selected by clicking and a black circle is only displayed inside the selected radio button 83; the file names of the log files for which a log was acquired in the period corresponding to this radio button 83 is displayed in the analysis target log display field 82.

The fault analysis screen 80 can be switched to a log information screen 84 as shown in FIG. 10B by clicking the desired file name among the file names displayed in the analysis target log display field 82.

The log information screen 84 selectively displays only the log information of the logs in the period corresponding to the radio button 83 selected at the time among the log information which is recorded in the log file with the file name that has been clicked. As a result, the system administrator is able to specify and analyze the cause of a system fault in the monitoring target system 2 then serving as the target based on the log information displayed on the log information screen 84.

### (1-4) Various Processing Relating to the System Fault Analysis Function

The processing content of various processing pertaining to the system fault analysis function according to this embodiment will be described next. Note that although the subject of the processing of the various processing is described as ‘programs’ hereinbelow, in reality it is understood that the corresponding CPUs 61 and 71 (FIG. 5) execute the processing on the basis of these ‘programs.’

### (1-4-1) Behavioral Model Creation Processing

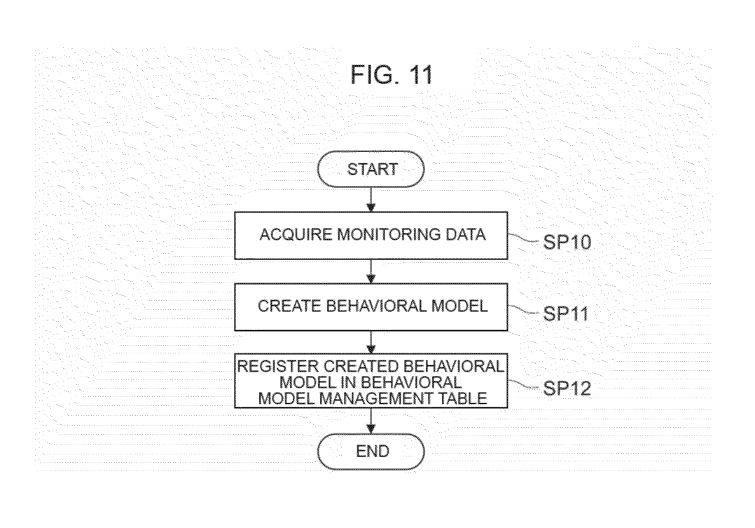

FIG. 11 shows a processing routine for behavioral model creation processing which is executed by the behavioral model creation program 65 installed on the analyzer 17. The behavioral model creation program 65 creates behavioral models ML for the corresponding monitoring target systems 2 according to the processing routine shown in FIG. 11.

In reality, the behavioral model creation program 65 starts the behavioral model creation processing shown in FIG. 11 when a behavioral model creation instruction designating the monitoring target system 2 for which the behavioral model ML is to be created (the instruction includes the system ID of the monitoring target system 2) is supplied via a scheduler (not shown) which is installed on the analyzer 17 or via the operational monitoring client 14. Further, the behavioral model creation program 65 first acquires all the information relating to the monitoring target system 2 designated in the behavioral model creation instruction, from the monitoring data management table 55 of the accumulation device 16 (SP10).

Thereafter, based on the information acquired in step SP10, the behavioral model creation program 65 receives an input of monitoring data which is contained in each piece of log information recorded in the corresponding log file, executes machine learning by means of a predetermined machine learning algorithm, and creates behavioral models ML for the monitoring target system 2 designated in the behavioral model creation instruction (SP11).

Then, by transferring the data of the behavioral models ML created in step SP11 together with a registration request to the accumulation device 16, the behavioral model creation program 65 registers the data of the behavioral models ML in the behavioral model management table 56 (SP12). At this time, the behavioral model creation program 65 also notifies the accumulation device 16 of the creation date and time of the behavioral models ML. As a result, the creation dates and times are registered in the behavioral model management table 56 in association with this behavioral models ML.

The behavioral model creation program 65 then ends the behavioral model creation processing.

### (1-4-2) Change Point Estimation Processing

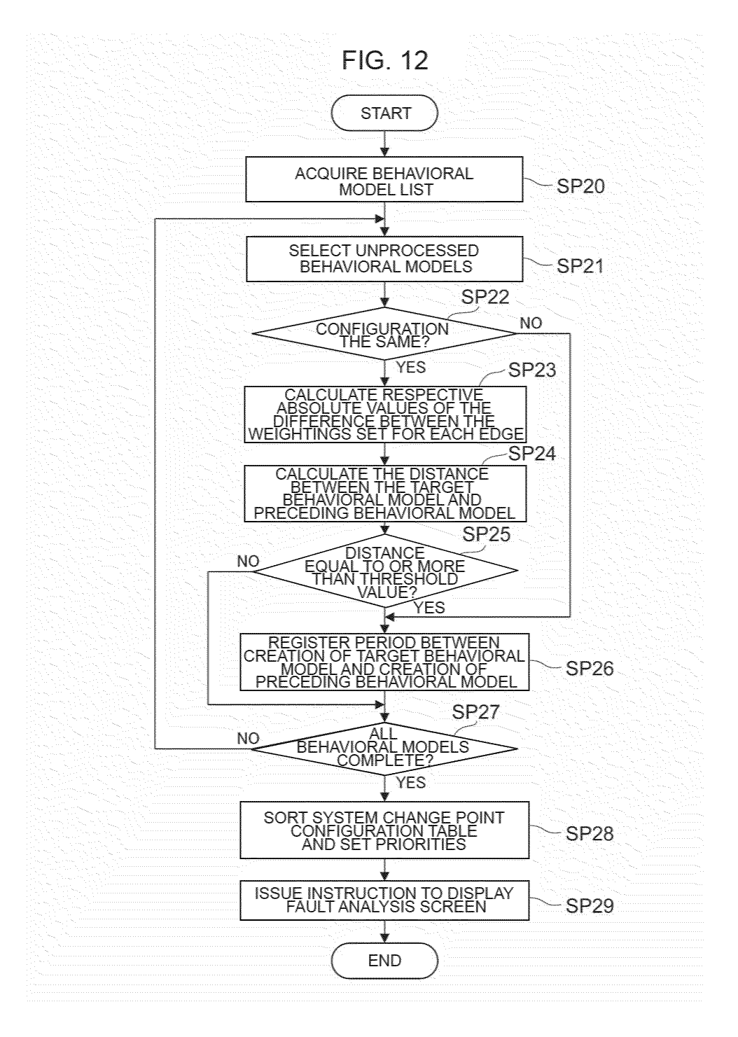

Meanwhile, FIG. 12 shows a processing routine for change point estimation processing which is executed by the change point estimation program 66 installed on the analyzer 17. The change point estimation program 66 estimates the periods in which the system change points of the monitoring target system 2 which is the current target are thought to exist according to the processing routine shown in FIG. 12. Note that a case where a Bayesian network is used as the machine learning algorithm will be described hereinbelow.

In the case of this computer system 1, when a system fault is generated, the system administrator operates the operational monitoring client 14, designates the system ID of the monitoring target system 2 in which the system fault occurred, and issues an instruction to perform a fault analysis on the monitoring target system 2. As a result, a fault analysis execution instruction containing the system ID of the monitoring target system 2 to be analyzed (the monitoring target system 2 in which the system fault occurred) is supplied to the analyzer 17 from the operational monitoring client 14.

When the fault analysis execution instruction is given, the change point estimation program 66 of the analyzer 17 starts the change point estimation processing shown in FIG. 12 and, using the system ID of the monitoring target system 2 to be analyzed which is contained in the fault analysis execution instruction then received as a key, first acquires a list of behavioral models in which the data of all the corresponding behavioral models ML (FIG. 6) is registered (SP20).

More specifically, the change point estimation program 66 extracts the system ID of the monitoring target system 2 to be analyzed from the fault analysis execution instruction thus received, and transmits a list transmission request to transmit a list (hereinafter called a ‘behavioral model list’) displaying the data of all the behavioral models ML of the monitoring target system 2 which was assigned the extracted system ID, to the accumulation device 16.

The accumulation device 16, which receives the list transmission request, searches the behavioral model management table 56 (FIG. 5) for the behavioral models ML of the monitoring target system 2 which was assigned the system ID designated in the list transmission request, and creates the foregoing behavioral model list which displays the data of all the behavioral models ML detected in the search. Further, the accumulation device 16 transmits the behavioral model list then created to the analyzer 17. As a result, the change point estimation program 66 acquires the behavioral model list displaying the data of all the behavioral models ML of the monitoring target system 2 to be analyzed.

Thereafter, the change point estimation program 66 selects one of the unprocessed behavioral models ML from among the behavioral models ML for which data is displayed in the behavioral model list (SP21) and judges whether or not the components of the selected behavioral model (hereinafter called the ‘target behavioral model’) ML and of the behavioral model ML which was created directly beforehand (hereinafter called the ‘preceding behavioral model’), of the same monitoring target system 2 as the former behavioral model ML, are the same (SP22). This judgment is made for the target behavioral model ML and preceding behavioral model ML by sequentially comparing each node and the link information between each node to determine if the nodes and link information are the same, starting with the initial node.

Here, if a negative result is obtained in this judgment, this means that there has been a change in the system configuration of the monitoring target system 2 or a change in the monitoring target items (an item addition or removal or the like) during the time between the creation of the preceding behavioral model ML and the time the target behavioral model ML was created. Further, in such a case, there is a risk that this system configuration change will cause a system fault.

Accordingly, the change point estimation program 66 then transmits the period between the creation date and time of the preceding behavioral model ML and the creation date and time of the target behavioral model ML and the system ID of the corresponding monitoring target system 2 to the accumulation device 16 together with a registration request and registers the system ID and period in the system change point configuration table 57 (SP56). The change point estimation program 66 then moves to step SP27.

In contrast, if an affirmative result is obtained in the judgment of step SP22, this means that the configuration of the monitoring target system 2 has not changed during the time between the creation of the preceding behavioral model ML and the time the target behavioral model ML was created. Thus, the change point estimation program 66 then continuously calculates the distance between the target behavioral model ML and the preceding behavioral model ML in steps SP23 to SP26, and if the distance is equal to or greater than a predetermined threshold (distance threshold), the change point estimation program 66 estimates that a system change point exists in the interval between the creation time of the preceding behavioral model ML and the creation time of the target behavioral model ML.

That is, the change point estimation program 66 calculates absolute value of the difference between weighted values which are configured for each edge for the target behavioral model ML and the preceding behavioral model ML (SP23). For example, in a case where the target behavioral model ML is a behavioral model created at time t1 in FIG. 6 and the preceding behavioral model ML is a behavioral model created at time t0 in FIG. 6, the weighted value for the edge from node A to node B of the target behavioral model ML is ‘0.9,’ and the weighted value for the edge from node A to node B of the preceding behavioral model ML is ‘0.8.’ The absolute value of the difference between these weighted values is therefore calculated as ‘0.1’ (=0.9−0.8). Further, the change point estimation program 66 similarly calculates the absolute value of the difference between the weighted values for the edge from node A to node C, the absolute value of the difference between the weighted values for the edge from node C to node D, and the absolute value of the difference between the weighted values for the edge from node C to node E respectively.

The change point estimation program 66 subsequently calculates the distance between the target behavioral model ML and preceding behavioral model ML (SP24). For example, in the foregoing example in FIG. 6, since the absolute value of the difference between the weighted values for the edge from node A to node C of the target behavioral model ML and preceding behavioral model ML, the absolute value of the difference between the weighted values of the edge from node C to node D of the target behavioral model ML and preceding behavioral model ML, and the absolute value of the difference between the weighted values of the edge from node C to node E of the target behavioral model ML and preceding behavioral model ML are all ‘0.1,’ the change point estimation program 66 calculates the sum total of absolute values at the time of weighted values of each of the edges as the distance between the target behavioral model ML and preceding behavioral model ML, with this distance being “0.4.”

The change point estimation program 66 then judges whether the distance between the target behavioral model ML and preceding behavioral model ML calculated in step SP24 is greater than a distance threshold value (SP25). Note that this distance threshold value is a numerical value which is configured based on observation. For example, the system administrator is able to extract a suitable value for the distance threshold value while operating the system. Further, this value can be derived by analyzing the accumulated data while operating the system.

Further, if an affirmative result is obtained in this judgment, the change point estimation program 66 transmits the period between the creation date and time of the preceding behavioral model ML and the creation date and time of the target behavioral model ML and the system ID of the corresponding monitoring target system 2 to the accumulation device 16 together with a registration request, whereby this system ID and period are registered in the system change point configuration table 57 (SP26). The change point estimation program 66 then moves to step SP27.

Meanwhile, upon moving to step SP27, the change point estimation program 66 judges whether or not execution of the processing of steps SP21 to SP26 has been completed for all the behavioral models ML for which data is displayed in the behavioral model list acquired in step SP20 (SP27).

Further, if a negative result is obtained in this judgment, the change point estimation program 66 returns to step SP21 and, subsequently, while sequentially switching the behavioral model ML selected in step SP21 to another unprocessed behavioral model ML for which data is displayed in a behavioral model list, the change point estimation program 66 repeats the processing of steps SP21 to SP27.

In addition, when an affirmative result is obtained in step SP27 as a result of already completing execution of the processing of steps SP21 to SP26 for all the behavioral models ML displayed in the behavioral model list, the change point estimation program 66 issues an instruction to the accumulation device 16 to rearrange the entries (rows) for each of the system change points of the monitoring target system 2 being targeted which are registered in the system change point configuration table 57 in descending order according to the periods stored in the period field 57C (FIG. 9) (in order starting with the change point of the newest period). Further, the change point estimation program 66 issues an instruction to the accumulation device 16 to store the higher priorities (smaller numerical values) in descending order according to the periods stored in the period field 57C (in order starting with the priority of the newest period) in the priority field 57B (FIG. 9) for each of the rearranged entries (SP28). This is because the system administrator normally performs analysis in order starting with the newest system change point at the time of system fault analysis.

Further, the change point estimation program 66 issues an instruction (hereinafter called an ‘analysis result display instruction’) to the portal device 18 to display the fault analysis screen 80 (FIG. 10), which displays information on each of the system change points of the monitoring target system 2 being targeted, on the operational monitoring client 14 (SP29), and then ends the change point estimation processing.

### (1-4-3) Change Point Display Processing

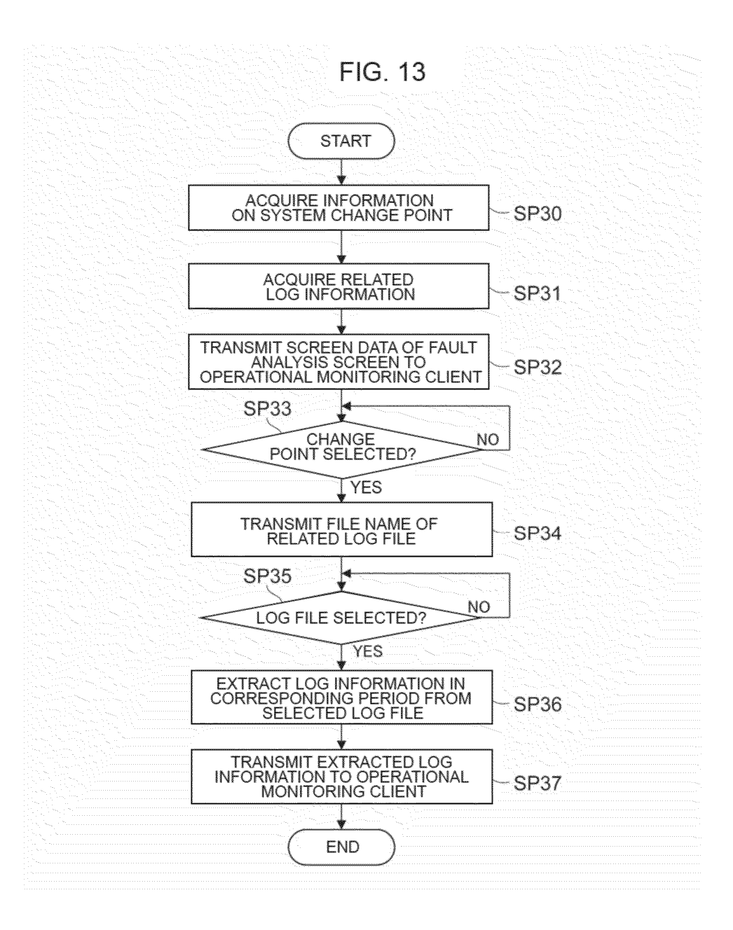

Meanwhile, FIG. 13 shows a processing routine for change point display processing which is executed by the change point display program 75 installed on the portal device 18. The change point display program 75 displays the fault analysis screen 80 and log information screen 84 and so forth described earlier with reference to FIG. 10 on the output device 46 of the operational monitoring client 14 according to the processing routine shown in FIG. 13.

In reality, upon receiving the foregoing analysis result display instruction issued by the change point estimation program 66 in step SP29 of the change point estimation processing (FIG. 12), the change point display program 75 starts the change point display processing shown in FIG. 13 and first acquires information relating to the system change points of the monitoring target system 2 designated in the analysis result display instruction from the system change point configuration table 57 (SP30).

More specifically, the change point display program 75 issues a request to the accumulation device 16 to transmit information pertaining to all the system change points (periods and priorities) of the monitoring target system 2 designated in the analysis result display instruction thus received. Accordingly, the accumulation device 16 reads information related to all the system change points of the monitoring target system 2 according to this request from the system change point configuration table 57 (FIG. 5), and transmits the information thus read to the portal device 18.

The change point display program 75 then acquires log information for all the logs pertaining to the monitoring target system 2 designated in the analysis result display instruction (SP31). More specifically, the change point display program 75 issues a request to the accumulation device 16 to transmit all the log information of the monitoring target system 2 designated in the analysis result display instruction. Accordingly, according to this request, the accumulation device 16 reads the file names of the log files, for which log information of all the logs relating to the monitoring target system 2 has been recorded, from the monitoring data management table 55, and transmits all the log information recorded in the log files with these file names to the portal device 18.

The change point display program 75 subsequently creates screen data for the fault analysis screen 80 described earlier with reference to FIG. 10A, based on information relating to the system change points acquired in step SP30 and sends the screen data thus created to the operational monitoring client 14. As a result, the fault analysis screen 80 is displayed on the output device 46 of the operational monitoring client 14 on the basis of this screen data (SP32). Further, the change point display program 75 then waits to receive notice that any of the periods displayed in the change point candidate list 81 (FIG. 10A) of the fault analysis screen 80 has been selected (SP33).

Furthermore, when the system administrator operates the input device 45 and clicks a radio button 83 (FIG. 10A) which is associated with a desired period from among the radio buttons 83 displayed in the change point candidate list 81 on the fault analysis screen 80, the operational monitoring client 14 transmits a transfer request to the portal device 18 to transfer the file names of all the log files for which log information of each log acquired in the period associated with this radio button 83 has been recorded. Accordingly, upon receiving this transfer request, the change point display program 75 transfers the file names of all the corresponding log files to the operational monitoring client 14 and displays these log file file names in the analysis target log display field 82 (FIG. 10A) of the fault analysis screen 80 (SP34).

Further, when the system administrator operates the input device 45 to select one file name from among the file names displayed in the analysis target log display field 82 of the fault analysis screen 80, the operational monitoring client 14 transmits a transfer request to the portal device 18 to transfer log information which is recorded in the log file with this file name. Accordingly, among the log information recorded in this log file, the change point display program 75 extracts only the log information of the log that was acquired in the period selected by the system administrator in step SP33, from among the log files acquired in step SP31 (SP36).

Further, the change point display program 75 creates screen data of the log information screen 84 (FIG. 10B) displaying all the log information extracted in step SP36 and transmits the created screen data to the operational monitoring client 14 (SP37). As a result, the log information screen 84 is displayed on the output device 46 of the operational monitoring client 14 based on the screen data.

The change point display program 75 subsequently ends the change point display processing.

### (1-5) Effects of Embodiment

As described hereinabove, with the computer system 1, as a result of the system administrator operating the operational monitoring client 14 when a system fault occurs in the monitoring target system 2, the fault analysis screen 80 displaying the period in which the system change point is estimated to exist can be displayed on the output device 46 of the operational monitoring client 14.

The system administrator is thus able to easily recognize the period in which the behavior of the monitoring target system 2 changed by way of the fault analysis screen 80 and, as a result, the time taken to specify and analyze the cause of a fault in the computer system can be shortened. It is thus possible to reduce the possibility of a system fault recurring after provisional measures have been taken and to improve the availability of the computer system 1.

### (2) Second Embodiment

### (2-1) Configuration of the Computer System According to this Embodiment

According to the first embodiment, system change points were extracted using only one machine learning algorithm as a machine learning algorithm. However, all machine algorithms have their own individual characteristics and therefore there is a risk of bias in the system change point detection results depending on which machine learning algorithm is used. Therefore, according to this embodiment, the system change points can be extracted by combining a plurality of machine learning algorithms.

Note that, hereinafter, the fact that the period in which the system change point occurs is estimated by using behavioral models ML created using a certain machine learning algorithm is expressed as ‘the period in which the system change point occurs is estimated using a machine learning algorithm.’ Further, the machine learning algorithm used in the creation of the behavioral models ML which are employed in the processing to estimate that a system change point exists in a certain period is expressed as ‘the machine learning algorithm used to estimate that a system change point exists in a period.’

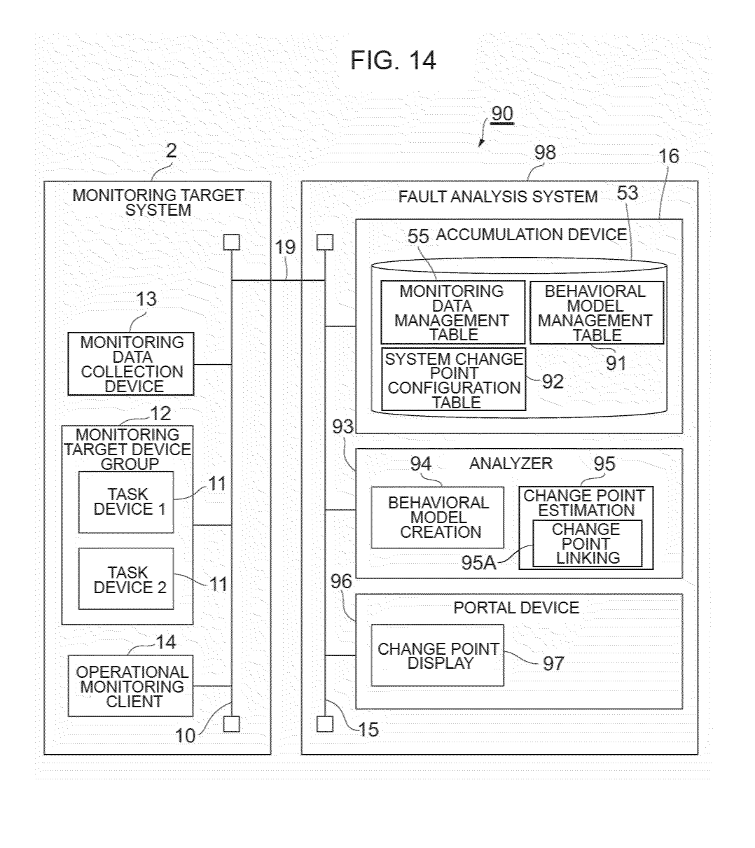

FIG. 14, in which the same reference numerals are assigned as the corresponding parts in FIG. 4, shows a computer system 90 according to this embodiment with such a system fault analysis function. This computer system 90 is configured in the same way as the computer system 1 according to the first embodiment except for the fact that the configurations of a behavioral model management table 91 and system change point configuration table 92 which are stored and held in the accumulation device 16 are different, that the behavioral model creation program 94 and change point estimation program 95 which are installed on the analyzer 93 are different, and the function or configuration of the change point display program 97 installed on the portal device 96 are different.

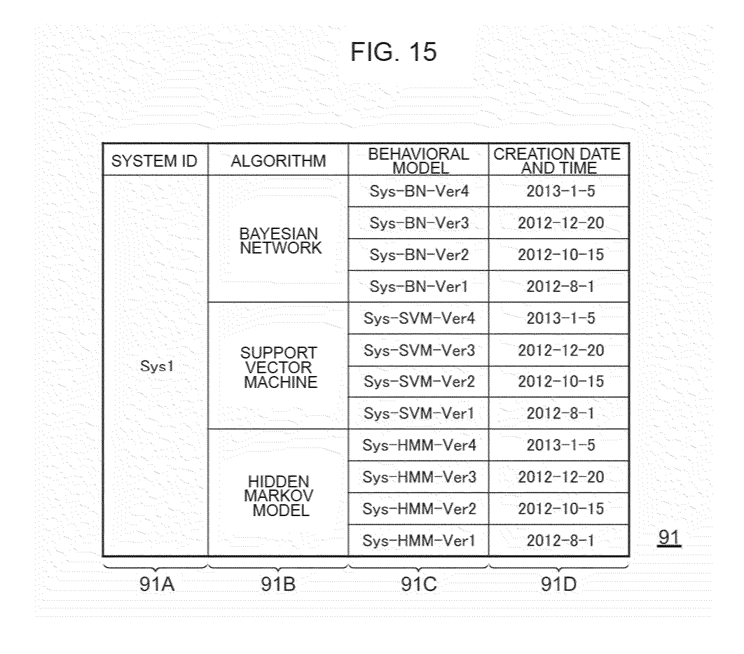

FIG. 15 shows the configuration of the behavioral model management table 91 according to this embodiment. As can also be seen from FIG. 15, the behavioral model management table 91 is configured from a system ID field 91A, an algorithm field 91B, a behavioral model field 91C, and a creation date and time field 91D.

Further, the system ID field 91A stores the system IDs of the monitoring target system 2 to be monitored, the algorithm field 91B stores the name of each machine learning algorithm configured as a machine learning algorithm which is to be pre-used for the corresponding monitoring target system 2. The behavioral model field 91C stores the names of the behavioral models ML (FIG. 6) created by using the corresponding machine learning algorithm for the corresponding monitoring target system 2, and the creation date-time field 91D stores the creation date and time of the corresponding behavioral models ML.

Accordingly, in the example in FIG. 15, it can be seen that, for the monitoring target system 2 known as ‘Sys1,’ on ‘2013-1-5,’ the behavioral model ML ‘Sys1-BN-Ver4’ was created by the ‘Bayesian network’ machine learning algorithm, the behavioral model ML ‘Sys1-SVM-Ver4’ was created by the ‘support vector machine’ machine learning algorithm, and the behavioral model ML ‘Sys1-HMM-Ver4’ was created by the ‘hidden Markov model’ machine learning algorithm, for example.

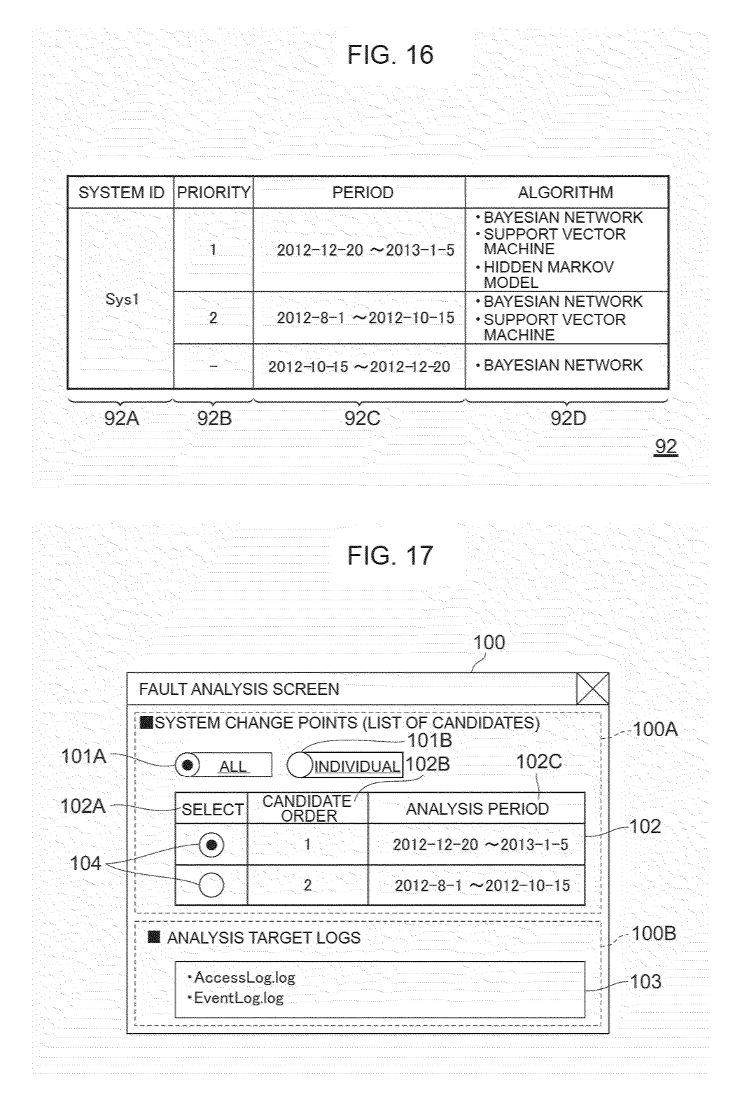

Further, FIG. 16 shows a configuration of the system change point configuration table 92 according to this embodiment. As is clear from FIG. 16, the system change point configuration table 92 is configured from a system ID field 92A, a priority field 92B, a period field 92C and an algorithm field 92D.

Further, the system ID field 92A, the priority field 92B and the period field 92C each store the same information as the corresponding system ID field 57A, priority field 57B and period field 57C of the system change point configuration table 57 (FIG. 9) according to the first embodiment. Further, the algorithm field 92D stores the names of the machine learning algorithms used to estimate that the system change points exist in the corresponding periods.

Accordingly, in the example of FIG. 16, it can be seen that for the monitoring target system 2 known as ‘Sys1,’ a system change point with a priority ‘1’ is estimated to exist in a period ‘2012-12-20 to 2013-1-5,’ for example, and that the machine learning algorithms used to estimate that the system change point exists in this period are the ‘Bayesian network,’ ‘support network machine,’ and ‘hidden Markov model.’ Note that the details of ‘-’ which appears in the priority field 92B in FIG. 16 will be provided subsequently.

Meanwhile, the behavioral model creation program 94 comprises a function which uses a plurality of machine learning algorithms to create behavioral models ML for each machine learning algorithm. Further, the behavioral model creation program 94 registers the data of each created behavioral model ML for each machine learning algorithm in the behavioral model management table 91 described earlier with reference to FIG. 15.

Further, the change point estimation program 95 possesses a function for calculating the distance between each of the behavioral models ML created for each of the plurality of machine learning algorithms. In a case where the calculated distance is equal to or more than a predetermined distance threshold value, the change point estimation program 95 estimates that a system change point exists in a period between the dates the behavioral models ML were created. Further, the change point estimation program 95 comprises a change point linking module 95A which possesses a function for combining the estimated system change points for each machine learning algorithm as described earlier. Furthermore, in a case where a system change point has been estimated to exist in the same period by a plurality of machine learning algorithms, the change point linking module 95A also executes consolidation processing to consolidate the entries (rows) of each machine learning algorithm in the system change point configuration table 92 into a single entry as shown in FIG. 16.

The change point display program 97 differs functionally from the change point display program 75 (FIG. 4) according to the first embodiment in that the configuration of the created fault analysis screen is different.

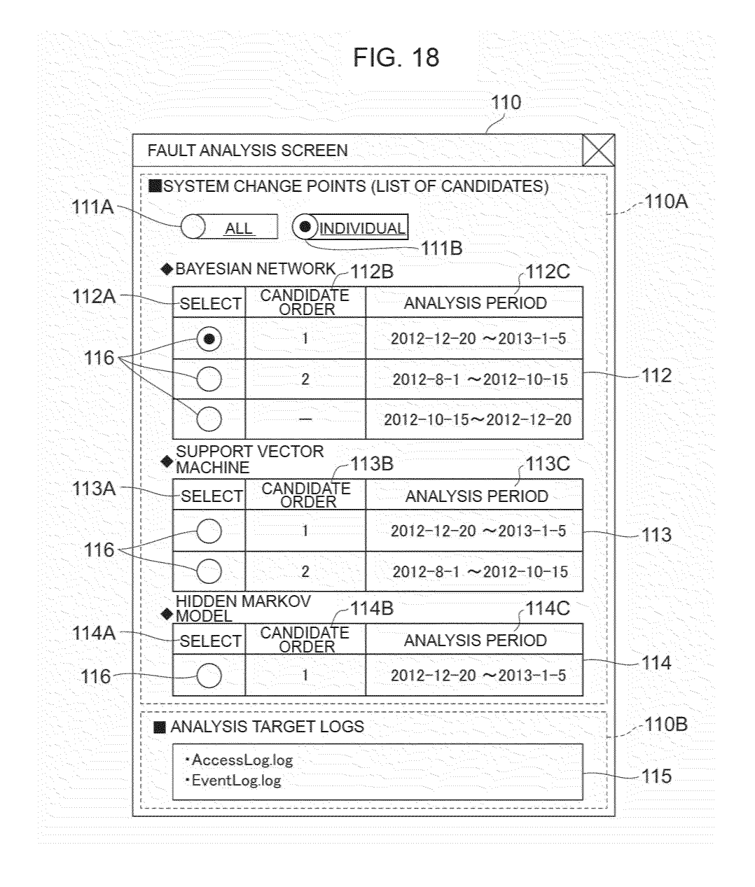

FIGS. 17 and 18 show a configuration of fault analysis screens 100, 110 which are created by the change point display program 97 according to this embodiment and displayed on the output device 46 of the operational monitoring client 14. FIG. 17 is a fault analysis screen (hereinafter called the ‘first fault analysis screen’) 100 which displays the consolidated results of the system change points for each of the plurality of machine learning algorithms, and FIG. 18 is a fault analysis screen (hereinafter called the ‘second fault analysis screen’) 110 in display form for displaying information on the system change points estimated using individual machine learning algorithms, for each machine learning algorithm.

As is also clear from FIG. 17, the first fault analysis screen 100 is configured from a system change point information display field 100A and an analysis target log display field 100B. Further, the system change point information display field 100A displays a first display form select button 101A, second display form select button 101B and a change point candidate list 102, and an analysis target log display field 103 is displayed in the analysis target log display field 100B.

The first display form select button 101A is a radio button which is associated with the display form for displaying the result of consolidating the periods in which system change points, extracted using each of the plurality of machine learning algorithms, are estimated to exist, and the string ‘All’ is displayed in association with the first display form select button 101A. Further, the second display form select button 101B is a radio button which is associated with a display form for displaying information on the periods in which the system change points estimated using each of the machine learning algorithms are thought to exist, separately for each machine learning algorithm, and the string ‘individual’ is displayed in association with the second display form select button 101B.

The first display form select button 101A and second display form select button 101B are such that only either one can be selected by clicking and a black circle is only displayed inside the selected first display form select button 101A or second display form select button 101B. Further, the first fault analysis screen 100 is displayed if the first display form select button 101A is selected and the second fault analysis screen 110 is displayed if the second display form select button 101B is selected.

In addition, the change point candidate list 102 is configured from a select field 102A, a candidate order field 102B and an analysis period field 102C. Further, the analysis period field 102C displays each of the consolidation result periods resulting from consolidating the periods in which the system change points estimated by the change point estimation program 95 using the plurality of machine learning algorithms are thought to exist, and the candidate order field 102B displays the priority assigned to the corresponding period in the system change point configuration table 92 (FIG. 16).

Furthermore, each select field 102A displays a radio button 104. Only either one of these radio buttons 104 can be selected by clicking and a black circle is only displayed inside the selected radio button 104; the file name of the log file, for which a log acquired in the period associated with the radio button 104 has been registered, is displayed in the analysis target log display field 103.

Further, the first fault analysis screen 100 can be switched to the log information screen 84 described earlier with reference to FIG. 10B by clicking the desired file name among the file names which are displayed in the analysis target log display field 103.

Meanwhile, as is clear from FIG. 18, the second fault analysis screen 110 is configured from a system change point information display field 110A and an analysis target log display field 110B. Furthermore, the system change point information display field 110A displays the first display form select button 111A and second display form select button 111B, and one or a plurality of change point candidate lists 112 to 114, which are associated with each of the preconfigured machine learning algorithms, for the monitoring target system 2 then serving as the target, and the analysis target log display field 110B displays an analysis target log display field 115.

The first display form select button 111A and second display form select button 111B possess the same configuration and function as the first display form select button 101A and second display form select button 101B of the first fault analysis screen 100 (FIG. 17), and hence a description of these buttons 111A and 111B is omitted here.

The change point candidate lists 112 to 114 are each configured from select fields 112A to 114A, candidate order fields 112B to 114B and analysis period fields 112C to 114C. Further, the analysis period fields 112C to 114C display each of the periods in which system change points are estimated to exist by the change point estimation program 95 (FIG. 14) using the corresponding machine learning algorithms, and the candidate order fields 112B to 114B display the priorities assigned to the corresponding periods in the system change point configuration table 92 (FIG. 16).

Radio buttons 116 are also displayed in each of the select fields 112A to 114A. Only one of these radio buttons 116 can be selected by clicking and a black circle is only displayed inside the selected radio button 116; the file names of the log files for which a log acquired in the period associated with this radio button 116 has been registered are displayed in the analysis target log display field 115.

Further, by clicking the desired file name among the file names displayed in the analysis target log display field 115, the second fault analysis screen 110 can be switched to the log information screen 84 described earlier with reference to FIG. 10B.

### (2-2) Various Processing Relating to the System Fault Analysis Function According to this Embodiment

### (2-2-1) Behavioral Model Creation Processing

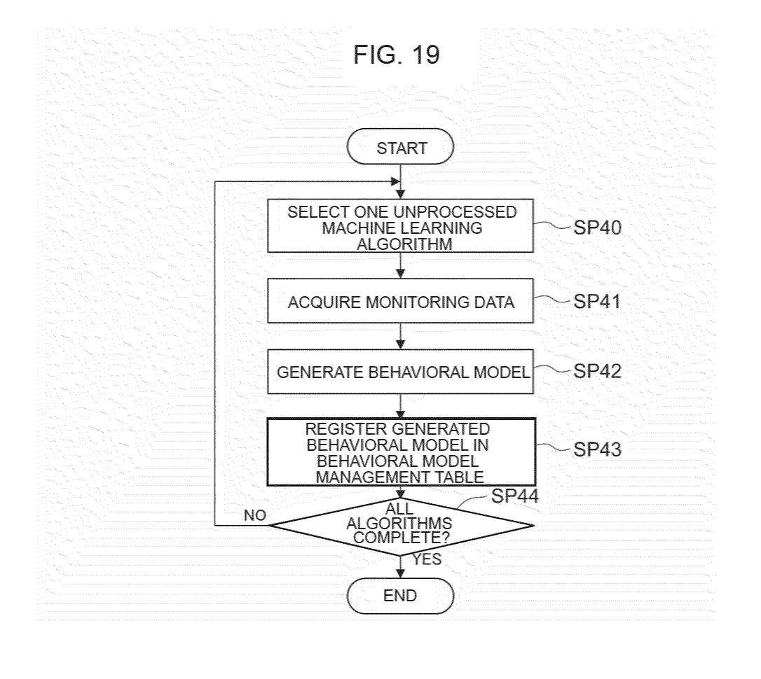

FIG. 19 shows a processing routine for behavioral model creation processing which is executed by the foregoing behavioral model creation program 94 (FIG. 14) which is installed on the analyzer 93 (FIG. 14). The behavioral model creation program 94 uses a plurality of machine learning algorithms to create the behavioral models ML of the corresponding monitoring target system 2 according to the processing routine shown in FIG. 19.

In reality, the behavioral model creation program 94 starts the behavioral model creation processing shown in FIG. 19 when a behavioral model creation instruction designating the system ID of the monitoring target system 2 for which the behavioral models ML are to be created is supplied from a scheduler (not shown) which is installed on the analyzer 93 or from the operational monitoring client 14, and first selects one machine learning algorithm from among the plurality of machine learning algorithms which have been preconfigured for this monitoring target system 2 (SP40).

Subsequently, by processing steps SP41 to SP43 in the same way as steps SP10 to SP12 of the behavioral model creation processing according to the first embodiment described earlier with reference to FIG. 11, the behavioral model creation program 94 then creates behavioral models ML by using the machine learning algorithm selected in SP40 and registers the data of the behavioral model ML thus created in the behavioral model management table 91 (FIG. 15).

The behavioral model creation program 94 then judges whether or not execution of the processing of steps SP41 to SP43 has been completed for all the machine learning algorithms preconfigured for the monitoring target system 2 then serving as the target (SP44).

Further, if a negative result is obtained in this judgment, the behavioral model creation program 94 returns to step SP40 and then repeats the processing of steps SP40 to SP44 while sequentially switching the machine learning algorithm selected in step SP40 to another unprocessed machine learning algorithm.

Further, if an affirmative result is obtained in step SP44 as a result of already completing execution of the processing of steps SP41 to SP43 for all the machine learning algorithms preconfigured for the monitoring target system 2 then serving as the target, the behavioral model creation program 94 ends the behavioral model creation processing.

As a result of the foregoing processing, behavioral models ML obtained using each of the machine learning algorithms preconfigured for the monitoring target system 2 then serving as the target are created and the data of the behavioral models ML thus created is registered in the behavioral model management table 91.

### (2-2-2) Change Point Estimation Processing

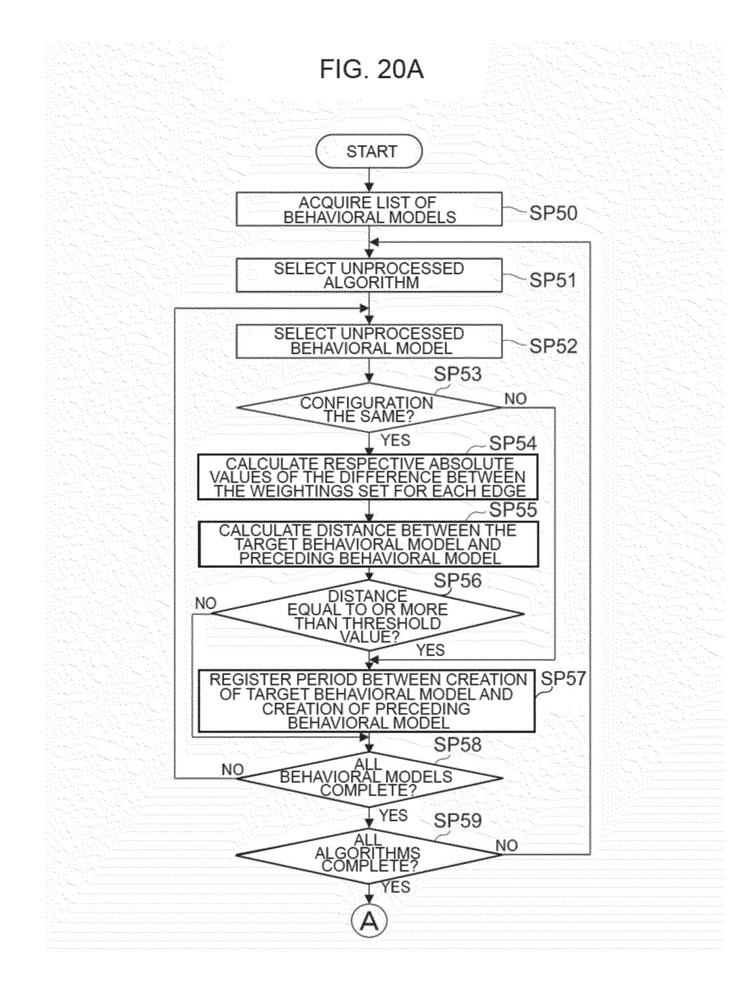

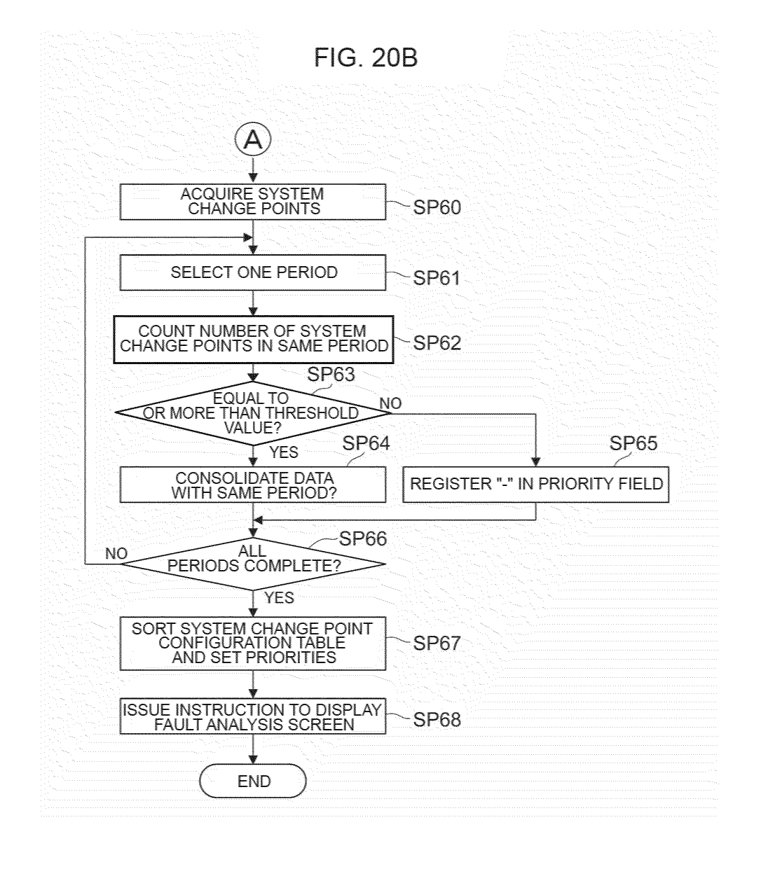

FIGS. 20A and 20B show a processing routine for the change point estimation processing which is executed by the change point estimation program 95 (FIG. 14) installed on the analyzer 93. The change point estimation program 95 estimates the system change points of the monitoring target system 2 then serving as the target according to the processing routine shown in FIGS. 20A and 20B.

In reality, when the foregoing fault analysis instruction (the instruction to execute processing to analyze system faults), which designates the monitoring target system 2 serving as the target, is supplied to the analyzer 93 from the operational monitoring client 14, the change point estimation program 95 starts the change point estimation processing shown in FIGS. 20A and 20B and first acquires a behavioral model list which displays the data of all the corresponding behavioral models ML by using, as a key, the system ID of the monitoring target system which is the analysis target contained in the fault analysis execution instruction then received in the same way as the change point estimation processing step SP20 according to the first embodiment described earlier with reference to FIG. 12 (SP50).

The change point estimation program 95 then selects one machine learning algorithm from among the plurality of machine learning algorithms preconfigured for this monitoring target system 2 (SP51).

Thereafter, by processing steps SP52 to SP58 in the same way as steps SP21 to SP27 of the behavioral model creation processing (FIG. 12) according to the first embodiment, the change point estimation program 95 then estimates the period in which a system change point exists based on the behavioral models ML created using the machine learning algorithm selected in step SP51, and registers information relating to this estimated period (system change point) in the system change point configuration table 92 (FIG. 16).

Note that, at this stage, the algorithm field 92D of the system change point configuration table 92 stores only the name of the machine learning algorithm then used, and, as per FIG. 16, a single algorithm field 92D does not store the names of the plurality of machine learning algorithms. That is, at this stage, information relating to the estimated system change points is always registered in the system change point configuration table 92 as a new entry.

Thereafter, the change point estimation program 95 judges whether or not execution of the processing of steps SP52 to SP58 has been completed for all the machine learning algorithms which are pre-registered for the monitoring target system 2 then serving as the target (SP59).

Further, if a negative result is obtained in this judgment, the change point estimation program 95 returns to step SP51 and then repeats the processing of steps SP51 to SP59 while sequentially switching the machine learning algorithm selected in step SP51 to another unprocessed machine learning algorithm. Consequently, estimation of the periods in which system change points obtained using these machine learning algorithms exist is performed for individual machine learning algorithms configured for the monitoring target system 2 then serving as the target, and information relating to the estimated periods is registered in the system change point configuration table 92.

Further, if an affirmative result is obtained in step SP59 as a result of already completing execution of the processing of steps SP51 to SP58 for all the machine learning algorithms preconfigured for the monitoring target system 2 serving as the target, the change point estimation program 95 calls the change point linking module 95A. Furthermore, once called, the change point linking module 95A accesses the accumulation device 16 and acquires information for all the entries relating to the monitoring target system 2 then serving as the target from among the entries in the system change point configuration table 92 (SP60).

The change point linking module 95A subsequently selects one unprocessed period from among the periods stored in the period field 92C for each entry for which information was acquired in step SP60 (SP61). The change point linking module 95A then counts the number of machine learning algorithms for which a system change point is estimated to exist in the same period as the period selected in step SP61 from among the entries for which information was acquired in step SP60 (SP62).

For example, suppose that the following five entries exist in the system change point configuration table 92 for this monitoring target system 2:

‘period=2012-12-20 to 2013-1-5, algorithm=Bayesian network’
‘period=2012-12-20 to 2013-1-5, algorithm=support vector machine’
‘period=2012-12-20 to 2013-1-5, algorithm=hidden Markov model’
‘period=2012-8-1 to 2012-10-15, algorithm=Bayesian network’
‘period=2012-8-1 to 2012-10-15, algorithm=support vector machine’
‘period=2012-10-15 to 2012-12-20, algorithm=Bayesian network’

In this case, for the period ‘2012-12-20 to 2013-1-5,’ since a system change point is estimated to exist by the three machine learning algorithms ‘Bayesian network,’ ‘support vector machine’ and ‘hidden Markov model,’ the count value for this period is then ‘3.’ Further, for the period ‘2012-8-1 to 2012-10-15,’ a system change point is estimated to exist by the two machine learning algorithms ‘Bayesian network’ and ‘support vector machine,’ and hence the count value for this period is ‘2.’ Further, for the period ‘2012-10-15 to 2012-12-20,’ since a system change point is estimated to exist by only the machine learning algorithm ‘Bayesian network,’ the count value for this period is ‘1.’

Thereafter, the change point linking module 95A judges whether or not periods exist for which the count value of this count is equal to or more than a predetermined threshold value (hereinafter called the ‘count threshold value’) (SP63). Note that the count threshold value, as it is used here, depends on the number of machine learning algorithms preconfigured for the monitoring target system 2 then serving as the target and is determined empirically. For example, the system administrator is able to extract a suitable value for the count threshold value while operating the system. Further, this value can be derived by analyzing data accumulated while operating the system.

Further, if an affirmative result is obtained in the judgment of step SP63, the change point linking module 95A executes consolidation processing to consolidate the data for the period selected in step SP61 (SP64). More specifically, the change point linking module 95A stores the names of all the algorithms for which a system change point exists in this period in the algorithm field 92D of one corresponding entry in the system change point configuration table 92, for the period selected in step SP61, and issues an instruction to the accumulation device 16 to delete the remaining corresponding entries from the system change point configuration table 92. As a result, a plurality of entries for the same period in the system change point configuration table 92 are consolidated as a single entry as per FIG. 16.

If, on the other hand, a negative result is obtained in the judgment of step SP63, after executing the same data consolidation processing as in step SP64 if necessary, the change point linking module 95A issues an instruction to the accumulation device 16 to register ‘-’ in the priority field 92B (FIG. 16) for the entry obtained by consolidating the data (SP65). Here, ‘-’ indicates that the number of machine learning algorithms that estimate that a system change point exists for the corresponding period has not reached the predetermined threshold value, and this means that the priority is the lowest among the candidates for the period in which a system change point is estimated to exist.

Thereafter, the change point linking module 95A judges whether or not execution of the processing of steps SP61 to SP65 has been completed for all the periods stored in the period field 92C for each entry for which information was acquired in step SP60 (SP66).

If a negative result is obtained in this judgment, the change point linking module 95A returns to step SP61 and then repeats the processing of steps SP61 to SP66 while switching the period selected in step SP61 to another unprocessed period.

Furthermore, if an affirmative result is obtained in step SP66 as a result of already completing execution of the processing of steps SP61 to SP65 for all the periods corresponding to the monitoring target system 2 then serving as the target which are registered in the system change point configuration table 92, the change point linking module 95A sorts the entries corresponding to the monitoring target system 2 then serving as the target in the system change point configuration table 92 with the periods in descending order (rearranges the entries in order starting with the newest period) and issues an instruction to the accumulation device 16 to store small numerical values in descending order in the priority field 92B for each entry where ‘-’ has not been stored in the priority field 92B (SP67).

The change point linking module 95A subsequently supplies an instruction to the portal device 96 (FIG. 14) to display the fault analysis screen 100 (FIG. 17) which displays information on each of the system change points of the monitoring target system 2 then serving as the target on the operational monitoring client 14 (SP68) and then ends the change point estimation processing.

### (2-3) Effects of Embodiment

As mentioned hereinabove, in the computer system 90 according to this embodiment, since periods in which system change points of the monitoring target system 2 are thought to exist are estimated by combining a plurality of machine learning algorithms, the generation of a bias in the system change point detection results which is dependent upon the machine learning algorithm used can be naturally and effectively prevented.

Therefore, with the computer system 90 according to this embodiment, in addition to the effects obtained according to the first embodiment, a highly accurate analysis result can be presented to the system administrator as the fault analysis results (the periods in which system change points exist). Consequently, with the computer system 90 according to this embodiment, the time taken to specify and analyze the cause of a fault in the computer system can be shortened further, and the availability of the computer system 90 can be improved still further over that of the first embodiment.

### (3) Third Embodiment

### (3-1) Configuration of Computer System According to this Embodiment

According to the first and second embodiments, the monitoring data collection device 13 of the monitoring target system 2 estimates the system change points based on only the monitoring data collected from the task devices 11 to be monitored. However, as described earlier, faults in the computer systems 1 and 90 mostly occur when there is some kind of change in a monitoring target system 2 which is operating stably, such as a configuration change or patch application, or when a user access pattern changes. Hence, system events such as a campaign or other task event, or a patch application also provide important clues when estimating periods containing system change points. Therefore, this embodiment is characterized in that periods which are estimated to contain system change points can be further filtered by using information relating to task events and system events (hereinafter called ‘task event information’ and ‘system event information’ respectively).

Note that when there is no particular need to distinguish between task events and system events, same will be jointly referred to hereinbelow as ‘events’ and when there is no particular need to distinguish between task event information and system event information, same will be jointly referred to ‘event information.’

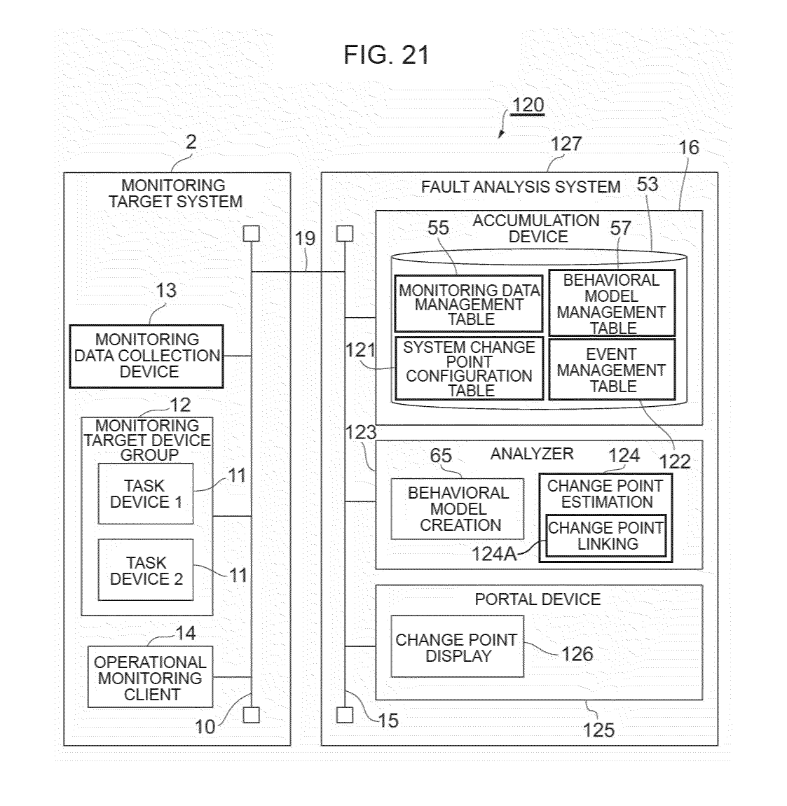

FIG. 21, in which the same reference numerals are assigned as the corresponding parts in FIG. 4, shows a computer system 120 according to this embodiment which possesses such a system fault analysis function. This computer system 120 is configured in the same way as the computer system 1 according to this first embodiment except for the fact that the configuration of a system change point configuration table 121 which is stored and held in the accumulation device 16 is different, that an event management table 122 is stored in a secondary storage device 53 of the accumulation device 16, and the functions and configuration of a change point estimation program 124 installed on an analyzer 123 and a change point display program 126 installed on a portal device 125 are different.

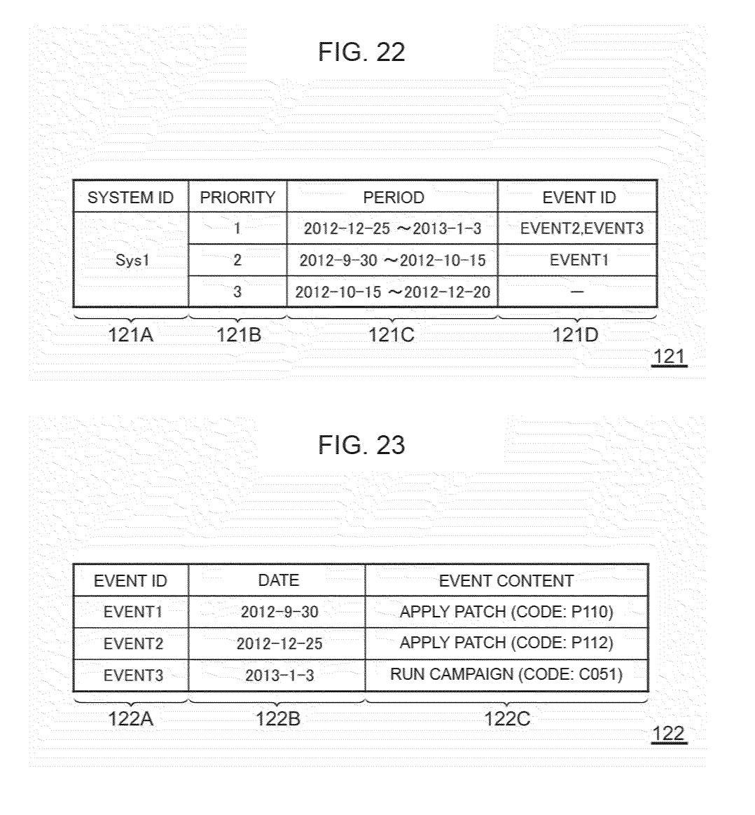

In reality, in the case of this embodiment, the system change point configuration table 121 is configured from a system ID field 121A, a priority field 121B, a period field 121C and an event ID field 121D, as shown in FIG. 22. Further, the system ID field 121A, priority field 121B and period field 121C each store the same information as the corresponding fields in the system change point configuration table 57 according to the first embodiment described earlier with reference to FIG. 9. Further, the event ID field 121D stores identifiers which are each assigned to events executed in the corresponding periods (hereinafter called ‘event IDs’).

Therefore, in the example in FIG. 22, it can be seen that, for the monitoring target system 2 known as ‘Sys1,’ events with the event IDs ‘EVENT2’ and ‘EVENT3’ are each executed in the period ‘2012-12-25 to 2013-1-3.’ Note that, in FIG. 22, it can be seen that an event ID is stored in the event ID field which corresponds to the period ‘2012-10-15 to 2012-12-20’ and that no event was generated in this period.

The event management table 122 is a table used to manage events performed by the user. Information relating to the events which are input by the system administrator via the operational monitoring client 14 is transmitted to the accumulation device 16 and registered in this event management table 122. As shown in FIG. 23, the event management table 122 is configured from an event ID field 122A, a date field 122B and an event content field 122C.

Furthermore, the event ID field 122A stores event IDs which are assigned to the corresponding events and the date field 122B stores the dates when these events are executed. The event content field 122C stores the content of these events.

Therefore, in the example in FIG. 23, it can be seen that the content of the event which was assigned the event ID ‘EVENT1’ and executed on ‘2012-9-30’ is a patch application to which the code ‘P110’ has been assigned (‘patch application (code: P110)’).

Meanwhile, like the change point estimation program 66 (FIG. 4) according to the first embodiment, the change point estimation program 124 possesses a function for extracting system change points based on the distance between each of the behavioral models ML created by the behavioral model creation program 65. Further, the change point estimation program 124 further comprises a change point linking module 124A which possesses a function for using event information to filter the periods in which the system change points extracted in this estimation are thought to exist. Further, the change point linking module 124A updates the periods of the corresponding system change points which are registered in the system change point configuration table 121 based on the result of such filter processing.

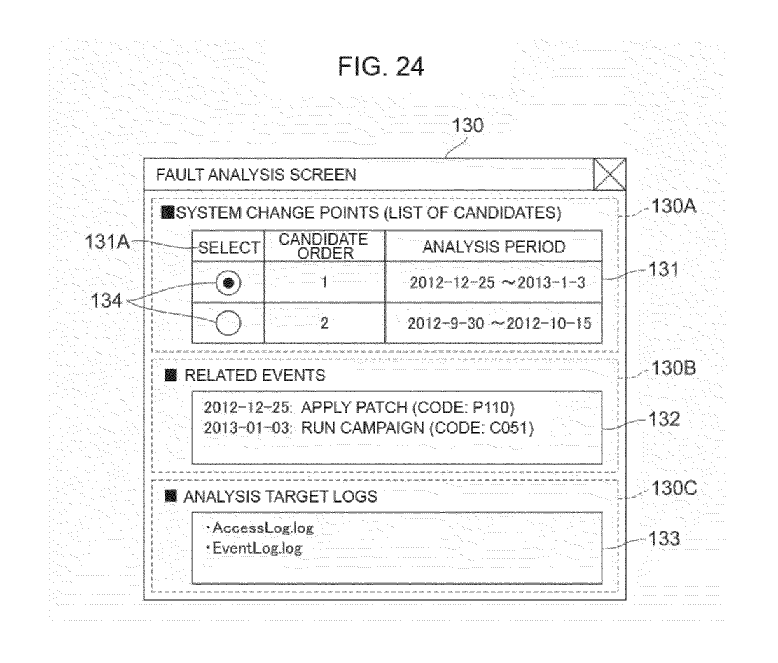

Meanwhile, the change point display program 126 is functionally different from the change point display program 75 (FIG. 4) according to the first embodiment in that the configuration of the fault analysis screen created is different. In reality, the change point display program 126 creates the fault analysis screen 130 as shown in FIG. 24 and causes the output device 46 of the operational monitoring client 14 to display this fault analysis screen 130.

As is also clear from FIG. 24, the fault analysis screen 130 according to this embodiment is configured from a system change point information display field 130A, a related event information display field 130B and an analysis target log display field 130C. Further, the system change point information display field 130A displays a change point candidate list 131 which displays periods in which system change points are estimated to exist by the change point estimation program 124 (FIG. 21). Further, the related event information display field 130B displays a related event information display field 132 and the analysis target log display field 130C displays an analysis target log display field 133.

The change point candidate list 131 possesses the same configuration and function as the change point candidate list 81 of the fault analysis screen 80 according to the first embodiment described earlier with reference to FIG. 10 and therefore a description of the change point candidate list 131 is omitted here. Further, by selecting a radio button 134 which corresponds to the desired period among the radio buttons 134 which are displayed in each of the select fields 131A of the change point candidate list 131 via the fault analysis screen 130 according to this embodiment, information relating to events performed in this period (execution date and content) can be displayed in the related event information display field 132 and the file names of log files in which logs acquired in this period are recorded can be displayed in the analysis target log display field 133.

Further, by clicking the desired file names among the file names displayed in the analysis target log display field 133, the fault analysis screen 130 can be switched to the log information screen 84 described earlier with reference to FIG. 10B.

### (3-2) Change Point Estimation Processing According to this Embodiment

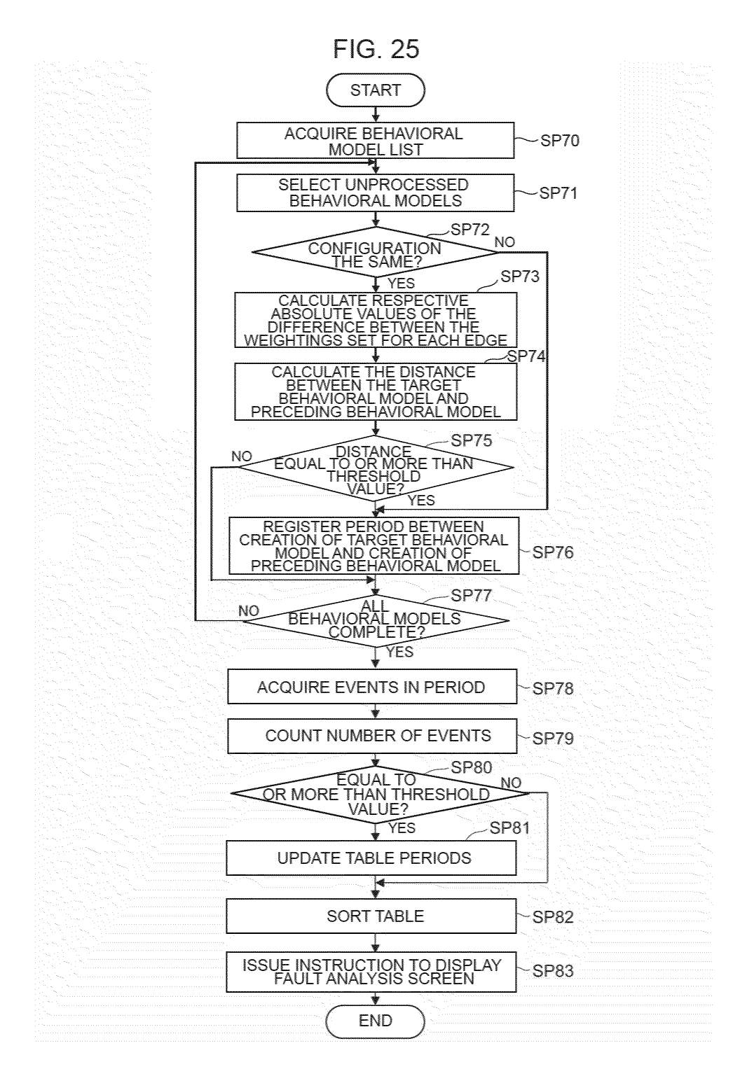

FIG. 25 shows a processing routine for the change point estimation processing according to this embodiment which is executed by the change point estimation program 124 (FIG. 21). The change point estimation program 124 estimates the period in which the system change points of the monitoring target system 2 then serving as the target exist according to the processing routine in FIG. 25.

In reality, when the foregoing fault analysis instruction (instruction to execute system fault analysis processing) which designates the monitoring target system 2 serving as the target is supplied to the analyzer 123 (FIG. 21) from the operational monitoring client 14, the change point estimation program 124 starts the change point estimation processing shown in FIG. 25 and processes steps SP70 to SP77 in the same way as steps SP20 to SP27 of the change point estimation processing according to the first embodiment described earlier with reference to FIG. 12. As a result, the periods in which the system change points for the monitoring target system 2 designated in the fault analysis execution instruction exist are estimated and information relating to the estimated periods (information relating to the extracted system change points) is stored in the system change point configuration table 121.

The change point estimation program 124 then calls the change point linking module 124A. Further, the called change point linking module 124A references the event management table 122 and acquires event information for all the events occurring in each period in which system change points are estimated to exist and which are registered in the system change point configuration table 121 (SP78). The change point linking module 124A counts the number of events executed in the corresponding periods for each of the system change points registered in the system change point configuration table 121 based on the event information acquired in step SP78 (SP79).

The change point linking module 124A then judges whether or not periods exist for which the count value is equal to or more than a predetermined threshold value (hereinafter called the ‘event number threshold value’) according to the count in step SP79 among the periods of each of the system change points recorded in the system change point configuration table 121 (SP80). Then, if a negative result is obtained in this judgment, the change point linking module 124A then moves to step SP82.

However, if an affirmative result is obtained in the judgment of step SP80, the change point linking module 124A updates the periods in the system change point configuration table 121 for which this count value is equal to or more than the event number threshold value, according to the event execution dates (SP81).

For example, in a case where the period field 121C (FIG. 22) of a certain entry in the system change point configuration table 121 stores the period ‘2012-12-20 to 2013-1-5’ and the event ID field 121D (FIG. 22) for this entry stores the event IDs ‘EVENT2, EVENT3,’ the execution date of the event ‘EVENT2’ is ‘2012-12-25’ and the execution date of the event ‘EVENT3’ is ‘2013-1-3.’

In this case, the change point linking module 124A judges that there is a high probability of a system change point existing in the period between ‘2012-12-25’ which is the execution date of ‘EVENT2’ and ‘2013-1-3’ which is the execution date of ‘EVENT3’ within the period between ‘2012-12-20’ when a certain behavioral model ML was created and ‘2013-1-5’ when the next behavioral model ML was created, and updates the period field 121C of this entry in the system change point configuration table 121 to ‘2012-12-25 to 2013-1-3’ (see FIGS. 9 and 22).

Furthermore, in a case where the period field 121C of another entry in the system change point configuration table 121 stores the period ‘2012-8-1 to 2012-10-15’ and the event ID field 121D of this entry stores the event ID ‘EVENT1,’ the execution date for the event ‘EVENT1’ is ‘2012-9-30.’

In this case, the change point linking module 124A judges that there is a high probability of a system change point existing on or after ‘2012-9-30’ which is the execution date of the event ‘EVENT1’ within the period between ‘2012-8-1’ when a certain behavioral model ML was created and ‘2012-10-15’ when the next behavioral model ML was created, and updates the period field 121C for this entry in the system change point configuration table 121 to ‘2012-9-30 to 2012-10-15’ (FIGS. 9 and 22).

Thereafter, the change point linking module 124A supplies an instruction to the accumulation device 16 to sort the entries for each of the system change points of the monitoring target system 2 then serving as the target and which are registered in the system change point configuration table 121 according to the count value for each period counted in step SP79 and the earliness or lateness of the period (SP82). More specifically, the change point linking module 124A issues an instruction to the accumulation device 16 to rearrange the entries in order starting with the period with the highest count value as counted in step SP79 and, for those periods with the same count value, in descending period order (in order starting with the newest period).

Further, the change point linking module 124A subsequently supplies an instruction to the portal device 125 (FIG. 21) to display the fault analysis screen 130 (FIG. 24), which displays information on each of the system change points of the monitoring target system 2 then serving as the target, on the operational monitoring client 14 (SP83), and then ends this change point estimation processing.

### (3-3) Effects of Embodiment

As described hereinabove, with the computer system 120 according to this embodiment, the periods in which system change points of the monitoring target system 2 estimated using the method according to the first embodiment are thought to exist are filtered using event information on task events and system events, and therefore periods that have been filtered further can be presented to the system administrator as reference periods when specifying and analyzing the cause of a system fault.

It is thus possible to further shorten the time required to specify and analyze the cause of a fault in the computer system 120 and reduce the probability of a system fault recurring after provisional measures have been taken, and hence the availability of the computer system 120 can be improved still further.

### (4) Fourth Embodiment

### (4-1) Computer System Configuration According to this Embodiment

If system change points are extracted using the method according to the first embodiment, the monitored item with the greatest change in value between the behavioral model ML created on the start date of the period in which the system change point is estimated to exist and the behavioral model ML created on the end date of the period is an item exhibiting a significant change in state, and an item exhibiting a significant change in state is considered a probable cause of a system fault. Hence, by presenting the system administrator with such information, a further shortening of the work time required for fault analysis can be expected. Therefore, this embodiment is characterized in that the monitored item with the greatest change is detected when extracting system change points and this information is presented to the system administrator.

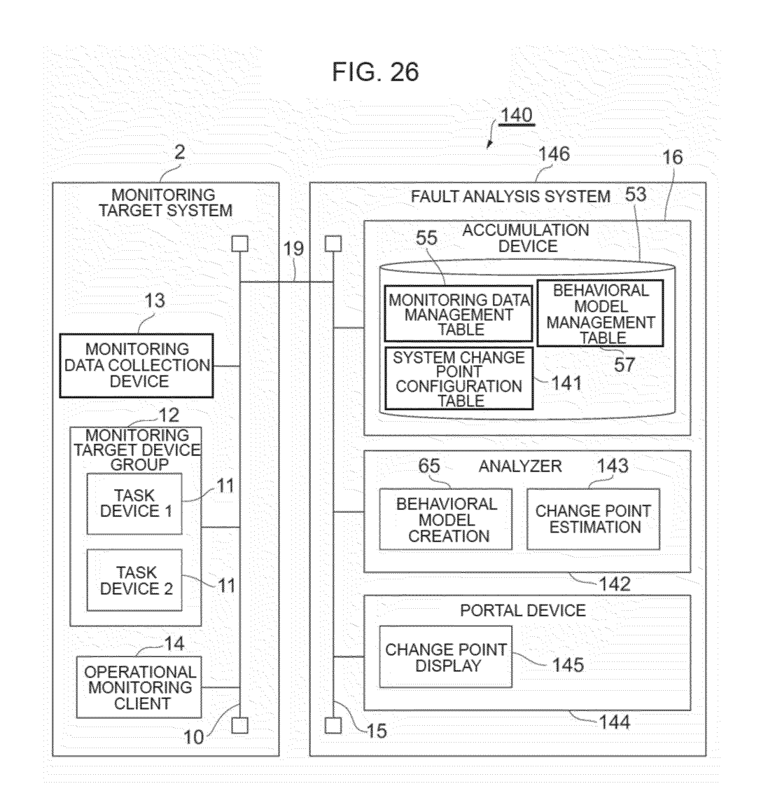

FIG. 26, in which the same reference numerals are assigned as the corresponding parts in FIG. 4, shows a computer system 140 according to this embodiment which possesses such a system fault analysis function. This computer system 140 is configured in the same way as the computer system 1 according to the first embodiment except for the fact that the configuration of a system change point configuration table 141 which is stored and held in the accumulation device 16 is different and the functions of a change point estimation program 143 which is installed on an analyzer 142 and of a change point display program 145 which is installed on a portal device 144 are different.

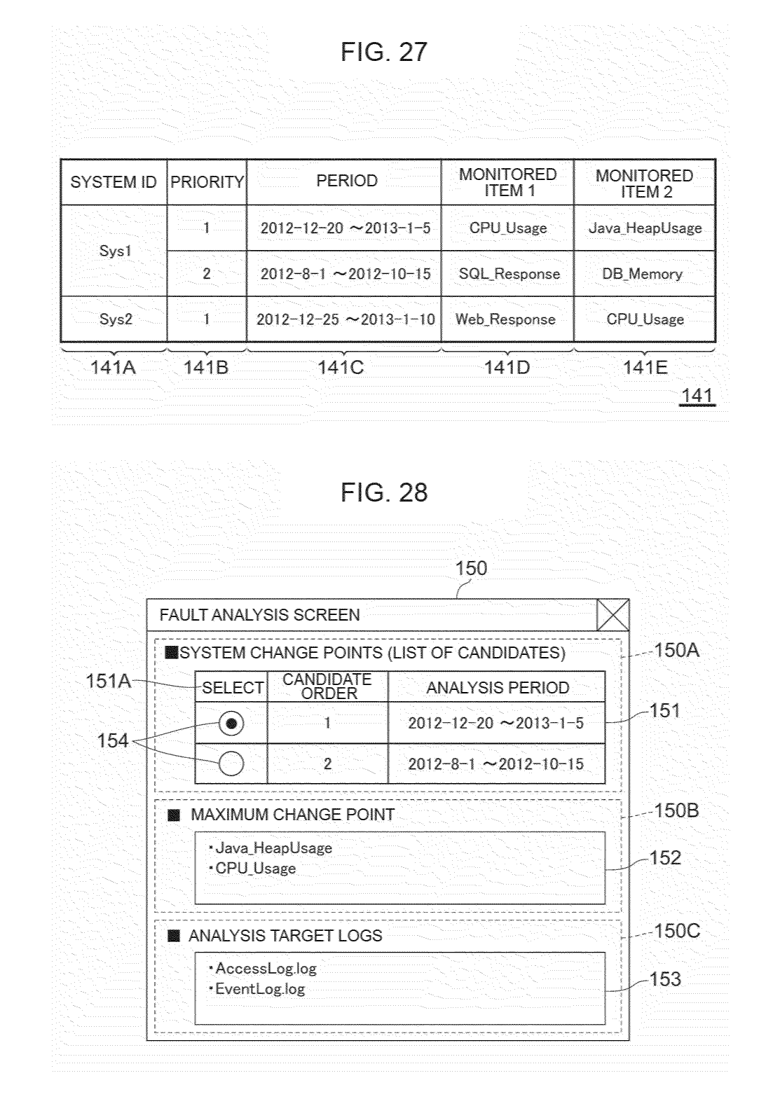

FIG. 27 shows the configuration of the system change point configuration table 141 according to this embodiment. This system change point configuration table 141 is configured from a system ID field 141A, a priority field 141B, a period field 141C, and a first monitored item field 141D and second monitored item field 141E.

Further, the system ID field 141A, priority field 141B and period field 141C store the same information as the corresponding fields in the system change point configuration table 57 according to the first embodiment described earlier with reference to FIG. 9. In addition, the first monitored item field 141D and second monitored item field 141E store identifiers for the monitored items showing the greatest changes in the corresponding periods. According to this embodiment, it is assumed that a Bayesian network is used as the machine learning algorithm and that the behavioral model ML is expressed using a graph structure. Hence, among each of the graph edges, the identifiers of the nodes (monitored items) at the two ends of the edge exhibiting the greatest change are stored in the first monitored item field 141D and second monitored item field 141E respectively.

Therefore, in the example of FIG. 27, it can be seen that in the monitoring target system 2 known as ‘Sys2,’ for example, it is estimated that there is a system change point in the period ‘2012-12-25 to 2013-1-10’ and that the monitored items exhibiting the greatest change in this period are the ‘web response time (Web_Response)’ and ‘CPU utilization (CPU_Usage).’

The change point display program 145 is functionally different from the change point display program 75 (FIG. 4) according to the first embodiment in that the configuration of the fault analysis screen created is different. In reality, the change point display program 145 creates the fault analysis screen 150 as shown in FIG. 28 and causes the output device 46 of the operational monitoring client 14 to display this fault analysis screen 150.

As is also clear from FIG. 24, the fault analysis screen 150 according to this embodiment is configured from a system change point information display field 150A, a maximum change point information display field 150B and an analysis target log display field 150C. Further, the system change point information display field 150A displays a change point candidate list 151 which displays periods in which system change points are estimated to exist by a change point estimation program 143 (FIG. 26). Further, the maximum change point information display field 150B displays a maximum change point information display field 152 and the analysis target log display field 150C displays an analysis target log display field 153.

The change point candidate list 151 possesses the same configuration and function as the change point candidate list 81 of the fault analysis screen 80 according to the first embodiment described earlier with reference to FIG. 10 and therefore a description of the change point candidate list 151 is omitted here. Further, by selecting a radio button 154 which corresponds to the desired period among the radio buttons 154 which are displayed in each of the select fields 151A of the change point candidate list 151 via the fault analysis screen 150 according to this embodiment, monitored item identifiers exhibiting the greatest change in the period can be displayed in the maximum change point information display field 152 and the file names of log files in which logs acquired in this period are recorded can be displayed in the analysis target log display field 153.

Further, by clicking the desired file names among the file names displayed in the analysis target log display field 153, the fault analysis screen 150 can be switched to the log information screen 84 described earlier with reference to FIG. 10B.

### (4-2) Change Point Estimation Processing According to this Embodiment

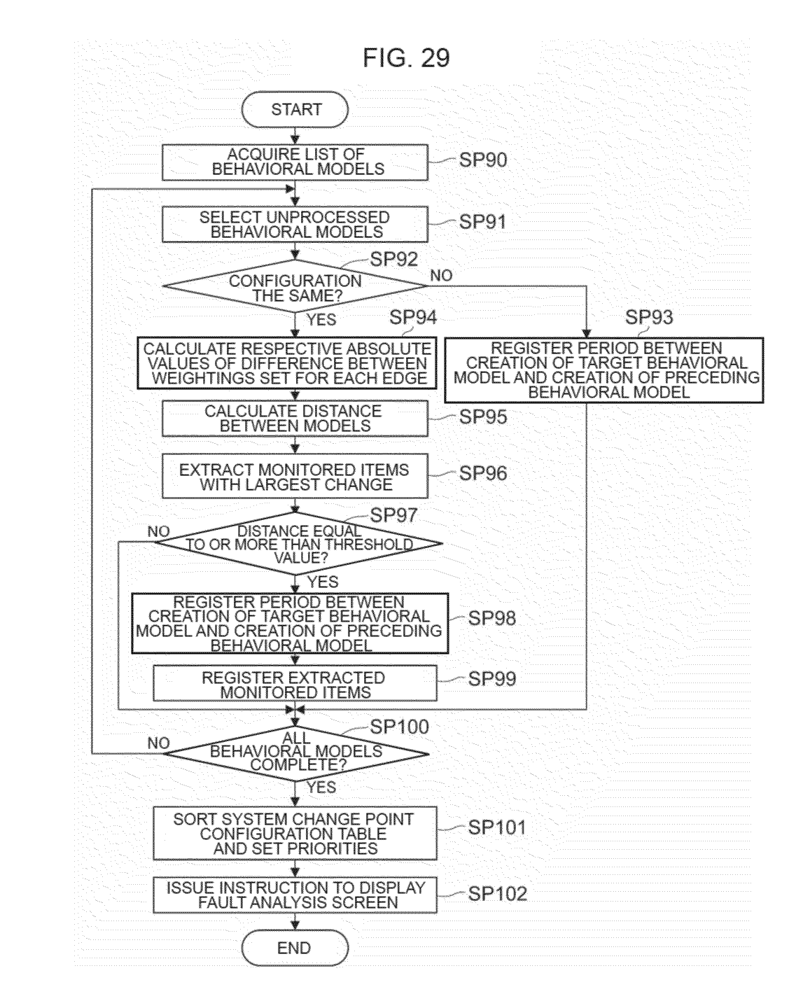

FIG. 29 shows a processing routine for the change point estimation processing according to this embodiment which is executed by the change point estimation program 143 (FIG. 26). The change point estimation program 143 estimates the period in which the system change points of the monitoring target system 2 then serving as the target is thought to exist according to the processing routine shown in FIG. 29, and detects the monitored items exhibiting the greatest change in this period.

In reality, when the foregoing fault analysis instruction (instruction to execute system fault analysis processing) which designates the monitoring target system 2 serving as the target is supplied to the analyzer 142 (FIG. 26) from the operational monitoring client 14, the change point estimation program 143 starts the change point estimation processing shown in FIG. 29 and first acquires a behavioral model list which displays data of all the behavioral models ML (FIG. 6) of the monitoring target system 2 which is the analysis target contained in the fault analysis execution instruction received at this time, in the same way as in step SP20 of the change point estimation processing according to the first embodiment described earlier with reference to FIG. 12 (SP90).

The change point estimation program 143 then selects one unprocessed behavioral model ML from among the behavioral models ML for which data is displayed in the behavioral model list (SP91) and judges whether or not the components of the selected behavioral model (target behavioral model) ML are the same as in the behavioral model (preceding behavioral model) ML that was created immediately before, in the same monitoring target system 2 as the target behavioral model ML (SP92). This judgment is carried out in the same way as step SP22 of the change point estimation processing (FIG. 12) according to the first embodiment.

Further, when a negative result is obtained in this judgment, the change point estimation program 143 transmits the period between the creation date of the preceding behavioral model ML and the creation date of this target behavioral model ML, and the system ID of the corresponding monitoring target system 2 to the accumulation device 16 together with a registration request, and registers this system ID and period in the system change point configuration table 141 (SP93). The change point estimation program 143 then advances to step SP100.

If, on the other hand, a configuration result is obtained in the judgment of step SP92, the change point estimation program 143 calculates the distance between the target behavioral model ML and the preceding behavioral model ML by processing steps SP94 and SP95 in the same way as steps SP23 and SP24 of the change point estimation processing (FIG. 12) according to the first embodiment.

The change point estimation program 143 subsequently detects the monitored item exhibiting the greatest change (SP96). In the case of this embodiment, since the behavioral model is assumed to have a graph structure, the change point estimation program 143 selects the edge with the greatest absolute value for the difference between the weightings of each edge calculated in step SP94 and extracts the nodes (monitored items) at both ends of the edge.

The change point estimation program 143 then judges whether or not the distance between the target behavioral model ML and the preceding behavioral model ML, as calculated in step SP95, is greater than a distance threshold value (SP97). If a negative result is obtained in this judgment, the change point estimation program 143 then moves to step SP100.

If, on the other hand, an affirmative result is obtained in the judgment of step SP97, the change point estimation program 143 transmits the period between the creation date of the preceding behavioral model ML and the creation date of this target behavioral model ML, and the system ID of the corresponding monitoring target system 2 to the accumulation device 16 together with a registration request, whereby this system ID and period are registered in the system change point configuration table 141 (SP98).

In addition, the change point estimation program 143 subsequently transmits the identifier of the monitored item exhibiting the greatest change extracted in step SP96 to the accumulation device 16 together with a registration request, whereby the monitored item is registered in the system change point configuration table 141 (SP99).

The change point estimation program 143 then judges whether or not execution of the processing of steps SP91 to SP99 has been completed for all the behavioral models ML for which data is displayed in the behavioral model list acquired in step SP90 (SP100).

If a negative result is obtained in this judgment, the change point estimation program 143 returns to step SP91 and then repeats the processing of steps SP91 to SP100 while sequentially switching the behavioral model ML selected in step SP91 to another unprocessed behavioral model ML for which data is displayed in the behavioral model list.

Further, if an affirmative result is obtained in step SP100 as a result of already completing execution of the processing of steps SP91 to SP99 for all the behavioral models ML for which data is displayed in the behavioral model list, the change point estimation program 143 performs rearrangement of the corresponding entries in the system change point configuration table 141 and configures the priorities of the periods of these entries in the same way as step SP28 in the change point estimation processing (FIG. 12) according to the first embodiment (SP101).

Furthermore, the change point estimation program 143 supplies an instruction to the portal device 144 (FIG. 26) to display the fault analysis screen 150 (FIG. 28) which displays information on each of the system change points of the monitoring target system 2 then serving as the target on the operational monitoring client 14 (SP102) and then ends the change point estimation processing.

### (4-3) Effects of Embodiment

As mentioned hereinabove, in the computer system 140 according to this embodiment, since not only periods in which system change points of the monitoring target system 2 are estimated to exist, but also monitored items exhibiting the greatest changes in these periods, are shown to the system administrator when a system fault occurs in the monitoring target system 2, the time required to specify and analyze the cause of a fault in the computer system 140 can be shortened still further. It is thus possible to reduce the probability of a system fault recurring after provisional measures have been taken and to further improve the availability of the computer system 140.

### (5) Further Embodiments

Note that, although cases were described in the foregoing first to fourth embodiments where the distance between the behavioral models ML is calculated from the sum total of the absolute values of the differences between the weighted values for each of the edges of the behavioral models ML, the present invention is not limited to such cases, rather, this distance may also be calculated by taking the root mean square of the values of the differences between the weighted values for each edge of the behavioral models ML. Furthermore, the distance between the behavioral models ML may also be calculated from the maximum values for the absolute values of the differences between the weighted values for each edge of the behavioral models ML, and a variety of other calculation methods may be widely applied as methods for calculating the distance between the behavioral models ML.

Incidentally, when the support vector machine is used as a machine learning algorithm and the behavioral models ML thus created cannot be expressed using a graph structure, the distance between the behavioral models ML may also be calculated by comparing the differences in distance values between each monitoring data value and the maximum-margin hyperplane between one behavioral model ML and the next, for example. The method of calculating the distance between the behavioral models ML in such a case where the behavioral models ML cannot be expressed using a graph structure may depend upon the configuration of the behavioral models ML.

Moreover, although cases were described in the foregoing first to fourth embodiments where the fault analysis screens 80, 100, 110, 130 and 150 were configured as per FIGS. 10, 17, 18, 24 and 28 respectively, the present invention is not limited to such cases, rather, a variety of other configurations can be widely applied as the configurations of the fault analysis screens 80, 100, 110, 130 and 150.

In addition, cases were described in the foregoing first to fourth embodiments where priorities for system change points are used to establish a sorting order period by period or for the individual order of the machine learning algorithms which are used to estimate the corresponding periods as periods in which system change points exist; however, the present invention is not limited to such cases, rather, priorities may also be assigned in a sorting order in which sorting takes place according to the size of the distance between the behavioral models ML, for example, and a variety of other assignment methods can be widely applied as the method used to assign priorities.

Furthermore, although cases were described in the foregoing first to fourth embodiments where the data of behavioral models ML is stored in the behavioral model fields 56B and 91C (FIGS. 8 and 15) of the behavioral model management tables 56 and 91 (FIGS. 8 and 15), the present invention is not limited to such cases, rather, the behavioral model fields 56B and 91C of the behavioral model management tables 56 and 91 may also store only identifiers for each of the behavioral models ML and the data of each behavioral model ML may be saved in separate dedicated storage areas.

Likewise, although cases were described in the foregoing first to fourth embodiments where only the file names of the log files for which logs have been recorded are stored in the related log field 55C (FIG. 7) in the monitoring data management table 55 (FIG. 7) and the log files themselves are stored in a separate storage area in the secondary storage device 53 of the accumulation device 16, the present invention is not limited to such cases, rather, the log information of all the corresponding logs may be stored in the related log field 55C of the monitoring data management table 55.

In addition, although cases were described in the foregoing first to fourth embodiments where the portal device 18, 96, 125, 140, which serves as a notification unit for notifying the user of the periods in which the behavior of the monitoring target system 2 is estimated to have changed, displays the fault analysis screen 80, 100, 110, 130, 150 as shown in FIGS. 10, 17, 18, 24 and 28 on the operational monitoring client 14, the present invention is not limited to such cases, rather, the portal device 18, 96, 125, 144 may display information relating to the periods in which the behavior of the monitoring target system 2 is estimated to have changed (periods containing system change points), on the operational monitoring client 14 in text format, for example, and a variety of other methods can be widely applied as the method for notifying the user of the periods in which the behavior of the monitoring target system 2 is estimated to have changed.

Furthermore, although cases were described in the foregoing first to fourth embodiments where the fault analysis system 3, 98, 127, 146 is configured from three devices, namely the accumulation device 16, analyzer 17, 93, 123, 142, and portal device 18, 96, 125, 144, the present invention is not limited to such cases, rather, at least the analyzer 17, 93, 123, 142 and portal device 18, 96, 125, 144 among these three devices may also be configured from one device. In this case, the behavioral model creation program 65, 94, change point estimation program 66, 95, 124, 143 and change point display program 75, 97, 126, 145 may be stored on one storage medium such as the main storage device and the CPU may execute these programs with the required timing.

Further, although cases were described in the foregoing first to fourth embodiments where a main storage device 62, configured from a volatile semiconductor memory in the analyzer 17, 93, 123, 142 and a main storage device 72, configured from a volatile semiconductor memory in the portal device 18, 96, 125, 144 are adopted as the storage media for storing the behavioral model creation program 65, 94, change point estimation program 66, 95, 124, 143 and change point display program 75, 97, 126, 145, the present invention is not limited to such cases, rather, a storage medium other than a volatile semiconductor memory such as, for example, a disk-type storage medium such as a CD (Compact Disc), DVD (Digital Versatile Disc), BD (Blu-ray (registered trademark) Disc), or a hard disk device or magneto-optical disk, or a nonvolatile semiconductor memory or other storage medium can be widely applied as the storage media for storing the behavioral model creation program 65, 94, change point estimation program 66, 95, 124, 143 and change point display program 75, 97, 126, 145.

Moreover, a case was described in the foregoing second embodiment where, when compiling the system change points extracted using a plurality of machine learning algorithms, the number of system change points within the same period is counted and, when the count value is equal to or more than a count threshold value, the data for this period is consolidated; however, the present invention is not limited to this case, rather, it is also possible to divide the count result obtained by counting the number of system change points in the same period by the number of machine learning algorithms used at the time, for example, and if this value is equal to or more than a fixed value, to consider this period to be a period in which a system change point is likely to exist, and if this value is less than the fixed value, to remove this period from those periods in which a system change point is likely to exist.

### INDUSTRIAL APPLICABILITY

The present invention can be widely applied to computer systems in a variety of forms.

### REFERENCE SIGNS LIST

1, 90, 120, 140 Computer system
2 Monitoring target system
3, 98, 127, 146 Fault analysis system
13 Monitoring data collection device
11 Task device
12 Monitoring target device group
14 Operational monitoring client
16 Accumulation device
17, 93, 123, 142 Analyzer
18, 96, 125, 144 Portal device
55 Monitoring data management table
57, 91 Behavioral model management table
56, 92, 121, 141 System change point configuration table
61, 71 CPU
65, 94 Behavioral model creation program
66, 95, 124, 143 Change point estimation program
75, 97, 126, 145 Change point display program
80, 100, 110, 130, 150 Fault analysis screen
84 Log information screen
95A, 124A Change point linking module

1. A fault analysis method which is executed in a fault analysis system for performing a fault analysis on a monitoring target system comprising one or more computers, comprising:
a first step in which the fault analysis system continuously acquires, from the monitoring target system, monitoring data which is statistical data for monitored items of the monitoring target system, and creates behavioral models which are obtained by modeling the behavior of the monitoring target system at regular or irregular intervals based on the acquired monitoring data;
a second step in which the fault analysis system calculates the respective differences between two consecutively created behavioral models and estimates, based on the calculation result, a period in which the behavior of the monitoring target system has changed; and
a third step in which the fault analysis system notifies a user of the period in which the behavior of the monitoring target system is estimated to have changed.

2. The fault analysis method according to claim 1,
wherein, in the first step, the fault analysis system creates the behavioral models of the monitoring target system by means of a machine learning algorithm to which the monitoring data is input.

3. The fault analysis method according to claim 1,
wherein, in the second step, the fault analysis system calculates the differences between each of the consecutive behavioral models from a sum total of absolute values of the differences between weighted values for each edge of the behavioral models in each case, or calculates these same differences from the root mean square of the differences in the weighted values for each edge of the behavioral models, or calculates these same differences from a maximum value of the absolute values of the differences between the weighted values for each edge which the behavioral models comprise.

4. The fault analysis method according to claim 1,
wherein, in the third step, the fault analysis system notifies the user of all the periods in which the behavior of the monitoring target system is estimated to have changed, and
notifies the user selectively of log information on logs in the period selected by the user from among the notified periods.

5. The fault analysis method according to claim 2,
wherein, in the first step, the fault analysis system creates the behavioral models of the monitoring target system by means of a plurality of the machine learning algorithm respectively,
wherein, in the second step, the fault analysis system estimates each of the periods in which the behavior of the monitoring target system has changed based on the size of the differences between each of the behavioral models created by the machine learning algorithm, for each of the machine learning algorithms, and consolidates information relating to the same period for each of the periods in which the behavior of the monitoring target system has changed and which were estimated using each of the machine learning algorithms, and
wherein, in the third step, the fault analysis system notifies the user of information relating to the consolidated periods.

6. The fault analysis method according to claim 5,
wherein, in the third step, the fault analysis system notifies the user of the periods in which the behavior of the monitoring target system has changed and which were estimated based on the behavioral models created by the machine learning algorithms, by dividing up these periods according to each machine learning algorithm, in response to a request from the user.

7. The fault analysis method according to claim 1,
wherein, in the second step, the fault analysis system filters the range of periods in which the behavior of the monitoring target system has changed and which were estimated based on the size of the differences between each of the behavioral models, based on information on at least either task-based events or events in which the configuration of the monitoring target system has changed.

8. The fault analysis method according to claim 1,
wherein, in the second step, when calculating the difference between the behavioral models, the fault analysis system detects each of the monitored items exhibiting the greatest change between each of the behavioral models, and
wherein, in the third step, the fault analysis system notifies the user of the monitored items exhibiting the greatest change in the behavioral models in periods in which the behavior of the monitoring target system is estimated to have changed, together with information relating to these periods.

9. A fault analysis device, comprising, in a fault analysis system for performing a fault analysis on a monitoring target system comprising one or more computers:
a behavioral model creation which continuously acquires, from the monitoring target system, monitoring data which is statistical data for monitored items of the monitoring target system, and creates behavioral models which are obtained by modeling the behavior of the monitoring target system at regular or irregular intervals based on the acquired monitoring data;
an estimation unit which calculates the respective differences between two consecutively created behavioral models and estimates, based on the calculation result, a period in which the behavior of the monitoring target system has changed; and
a notification unit which notifies a user of the period in which the behavior of the monitoring target system is estimated to have changed.

10. A storage medium, in a fault analysis system for performing a fault analysis on a monitoring target system comprising one or more computers, for storing programs which execute processing comprising:
a first step of continuously acquiring, from the monitoring target system, monitoring data which is statistical data for monitored items of the monitoring target system, and creating behavioral models which are obtained by modeling the behavior of the monitoring target system at regular or irregular intervals based on the acquired monitoring data;
a second step of calculating the respective differences between two consecutively created behavioral models and estimating, based on the calculation result, a period in which the behavior of the monitoring target system has changed; and
a third step of notifying a user of the period in which the behavior of the monitoring target system is estimated to have changed.
